(19) United States
(12) Patent Application Publication
(10) Pub. No.: US 2013/0120451 A1
(43) Pub. Date: May 16, 2013

(54) IMAGE PROCESSING DEVICE, IMAGE PROCESSING METHOD, AND PROGRAM

(71) Applicant: Canon Kabushiki Kaisha, Tokyo (JP)

(72) Inventors: Yoshitaka Sasaki, Kawasaki-shi (JP); Ai Miyoshi, Kawasaki-shi (JP)

(73) Assignee: CANON KABUSHIKI KAISHA, Tokyo (JP)

(21) Appl. No.: 13/676,353

(22) Filed: Nov. 14, 2012

(30) Foreign Application Priority Data
Nov. 16, 2011 (JP) 2011-250649
Sep. 28, 2012 (JP) 2012-217162

(51) Int. Cl. G06T 5/50

(52) U.S. Cl. CPC G06T 5/50
USPC 345/633

(57) ABSTRACT

When combining a virtual subject with a background image, there may be a case where the hue is different between both and a feeling of difference arises. Moreover, conventionally, it is necessary to manually adjust rendering parameters etc. from the rendering result, which takes time and effort. An image processing device that combines a virtual subject with a background image to generate a combined image is characterized by including a correction coefficient deriving unit configured to derive a correction coefficient by performing rendering of a color object arranged in a position where the virtual subject is placed using an environment map indicating information of a light source around the virtual subject, a background image correcting unit configured to correct the background image based on the derived correction coefficient, and a combining unit configured to combine a corrected background image and the virtual subject using the environment map.

### BACKGROUND OF THE INVENTION

1. Field of the Invention

The present invention relates to an image processing device, an image processing method, and programs that generate a combined image of an actually photographed background image and a virtual subject created as a three-dimensional CG (Computer Graphics) object.

2. Description of the Related Art

In the field of video production, it has been made easy to combine a virtual subject which does not actually exist with an actually photographed image by using CG. At this time, lighting is important in order to generate a natural combined image. If lighting is set inappropriately, the hue, highlight, shade, etc., of the virtual subject are reproduced unnaturally.

As one of the lighting techniques using CG, the image-based lighting that represents GI (global illumination=environment light) using an image as a light source is known. In the image-based lighting, an omni-directional image of a place where a virtual subject is placed is photographed and the lighting of the virtual subject is performed using a panorama image (environment map) obtained from the photographed image. In the case of this technique, it is necessary to separately prepare a background image with which the virtual subject is combined and an environment map used to perform lighting of the virtual subject, and therefore, there arises the necessity to change one of them in accordance with the change in the viewpoint. As the technique to change the background image in accordance with the viewpoint, a technique is proposed which prepares a plurality of background images in advance and selects a background image in accordance with the movement of the viewpoint (Japanese Patent Laid-Open No. 2007-241868). Further, as the technique to change the environment map, a technique is proposed which extracts an object in the image photographed by a camera while referring to dictionary data and updates the environment map based on the result (Japanese Patent Laid-Open No. 2008-304268).

Moreover, as the technique to reproduce a virtual subject naturally, a technique is proposed which installs a virtual sphere painted in a desired color in a scheduled position and maps the color distribution and highlight distribution obtained from the rendering result thereof onto the virtual subject (Japanese Patent Laid-Open No. 2005-149027).

### SUMMARY OF THE INVENTION

However, by the techniques in Japanese Patent Laid-Open No. 2007-241868 and Japanese Patent Laid-Open No. 2008-304268, there is a case where it is not possible to obtain a natural combined image because the difference in lighting accompanying the change of the background image and the environment map is not taken into consideration. Further, by the technique in Japanese Patent Laid-Open No. 2005-149027, there is also a case where an unnatural combined image is obtained after all because the background image is not taken into consideration although the change in the lighting of the virtual subject is taken into consideration.

In addition, there occurs a difference in lighting also due to the difference of the camera that photographs the background image and the environment map and the difference in the photographing position, and therefore, the combined image is corrected by manually adjusting the rendering parameters etc. based on the rendering result conventionally, which takes time and effort.

An image processing device according to the present invention is an image processing device that combines a virtual subject with a background image to generate a combined image, and includes a correction coefficient deriving unit configured to derive a correction coefficient by performing rendering of a color object arranged in a position where the virtual subject is placed using an environment map indicating information of a light source around the virtual subject, a background image correcting unit configured to correct the background image based on the derived correction coefficient, and a combining unit configured to combine a corrected background image and the virtual subject using the environment map.

According to the present invention, it is possible to automatically generate a natural combined image in which the hue and brightness are matched between a background image and a virtual subject.

Further features of the present invention will become apparent from the following description of exemplary embodiments (with reference to the attached drawings).

### BRIEF DESCRIPTION OF THE DRAWINGS

FIG. 1 is a diagram showing an example of a hardware configuration of an image processing device according to a first embodiment;

FIGS. 2A to 2E are diagrams for explaining images etc. used in image-based lighting;

FIG. 3A is a diagram showing an actually-photographed photographing environment and FIG. 3B is a diagram showing a virtual photographing environment;

FIG. 4 is a functional configuration diagram of the image processing device according to the first embodiment;

FIG. 5 is a flowchart showing a general flow of image processing performed in the image processing device according to the first embodiment;

FIG. 6 is a flowchart showing details of correction coefficient derivation processing according to the first embodiment;

FIG. 7 is a diagram showing the way an achromatic color object is arranged;

FIG. 8 is a diagram showing the way a light beam is emitted from a virtual camera;

FIG. 9 is a flowchart showing details of light beam tracking processing;

FIG. 10 is a diagram showing a relationship between an emitted light beam and an achromatic color object;

FIG. 11 is a diagram showing the result of rendering of a white ball;

FIG. 12 is a flowchart showing details of background image correction processing;

FIG. 13 is a flowchart showing details of virtual subject combination processing;

FIG. 14 is a diagram visually showing a case where an emitted light beam intersects with a virtual subject and a case where not, respectively;

FIG. 15 a functional configuration diagram of an image processing device according to a second embodiment;

FIG. 16 is a flowchart showing a general flow of image processing performed in the image processing device according to the second embodiment;

FIG. 17 is a flowchart showing details of environment map correction processing;

FIGS. 18A and 18B are diagrams for explaining a state where exposure is inappropriate;

FIG. 19 is a functional configuration diagram of an image processing device according to a third embodiment;

FIG. 20 is a flowchart showing a general flow of image processing performed in the image processing device according to the third embodiment;

FIG. 21 is a flowchart showing details of correction coefficient derivation processing according to the third embodiment;

FIG. 22 is a diagram showing the result of rendering of a virtual subject having a virtual standard reflection characteristic in the third embodiment;

FIG. 23 is a flowchart showing details of virtual subject combination processing according to the third embodiment;

FIGS. 24A and 24B are diagrams showing a virtual subject after correction and the result of rendering after combination in the third embodiment;

FIG. 25 is a functional configuration diagram of an image processing device according to a fourth embodiment;

FIG. 26 is a flowchart showing a general flow of image processing performed in the image processing device according to the fourth embodiment;

FIG. 27 is a diagram showing an example of an environment map partial value table;

FIGS. 28A to 28F show a region corresponding to a pixel value average of each vector in the environment map partial value table;

FIG. 29 is a flowchart showing details of correction coefficient derivation processing according to the fourth embodiment;

FIG. 30 is a diagram for explaining the way a pixel value average as light that affects a virtual subject is acquired in the fourth embodiment;

FIG. 31 is a flowchart showing details of correction coefficient derivation processing according to a fifth embodiment;

FIG. 32 is a diagram showing the way a normal vector is acquired; and

FIG. 33 is a diagram for explaining the way a vector closest to the normal vector is selected.

### DESCRIPTION OF THE EMBODIMENTS

### First Embodiment

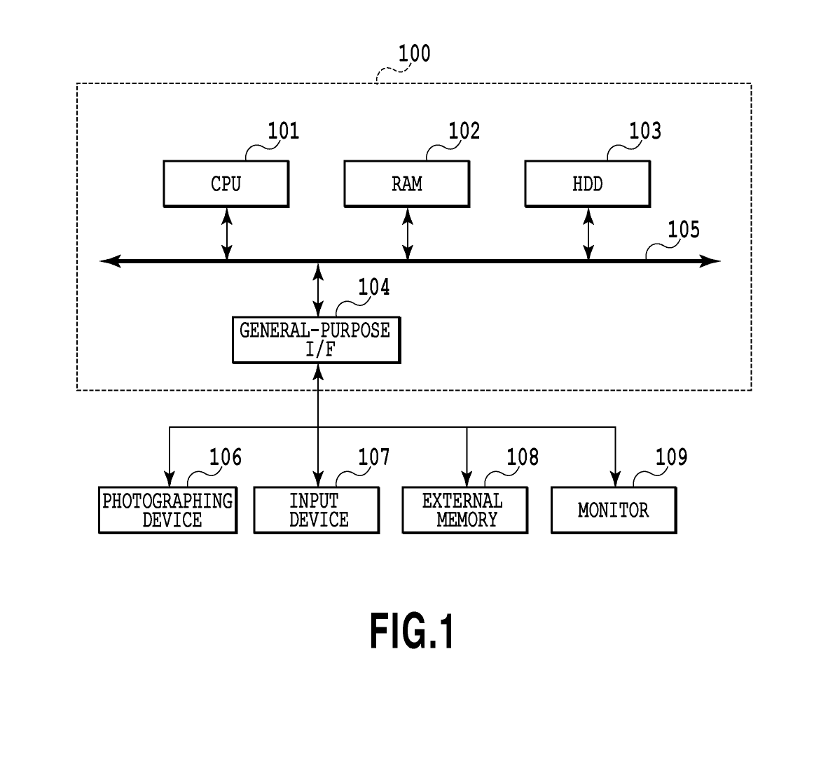

FIG. 1 is a diagram showing an example of a hardware configuration of an image processing device according to an embodiment.

An image processing device 100 includes a CPU 101, a RAM 102, an HDD 103, a general-purpose interface (I/F) 104, and a main bus 105. The general-purpose I/F 104 connects an image capturing device 106, such as a camera, an input device 107, such as a mouse and a keyboard, an external memory 108, such as a memory card, and a monitor 109, such as a liquid crystal panel, to the main bus 105.

An outline of processing in the image processing device 100 is as follows.

First, the CPU 101 activates and expands an image processing application stored in the HDD 103 in the RAM 102 and at the same time, displays a user interface (UI) on the monitor 109. Subsequently, various pieces of data stored in the HDD 103 and the external memory 108, pieces of data of images photographed by the image capturing device 106, instructions from the input device 107, etc., are transferred to the RAM 102. Further, according to the processing within the image processing application, various arithmetic operations are performed on data etc. transferred to the RAM 102 based on the instruction from the CPU 101. The results of arithmetic operation are displayed on the monitor 109 and stored in the HDD 103 and the external memory 108.

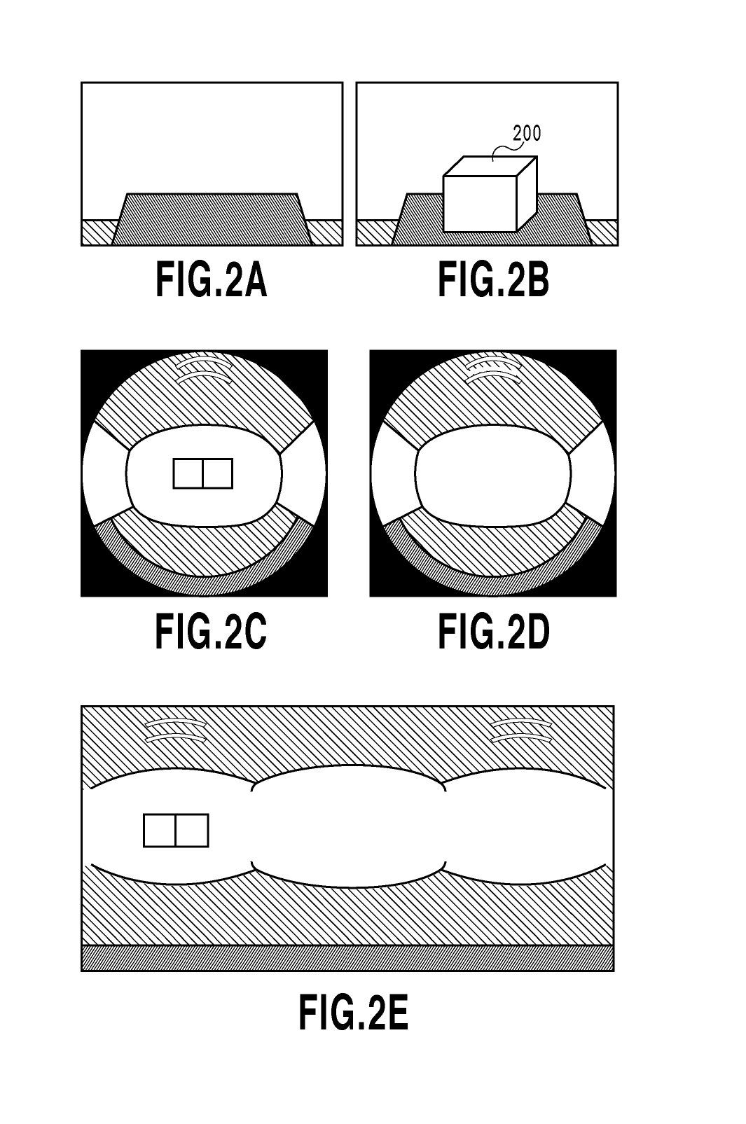

FIGS. 2A to 2E are diagrams for explaining images etc. used in the image-based lighting, which is the premise of the present invention. FIG. 2A shows an actually photographed background image. FIG. 2B shows a combined image obtained by combining a virtual subject 200 with the background image. FIGS. 2C and 2D respectively show surrounding images different in the photographing direction, which are the foundation of the environment map. FIG. 2E shows a panorama image (environment map) obtained by geometrically converting and combining the surrounding images of FIGS. 2C and 2D.

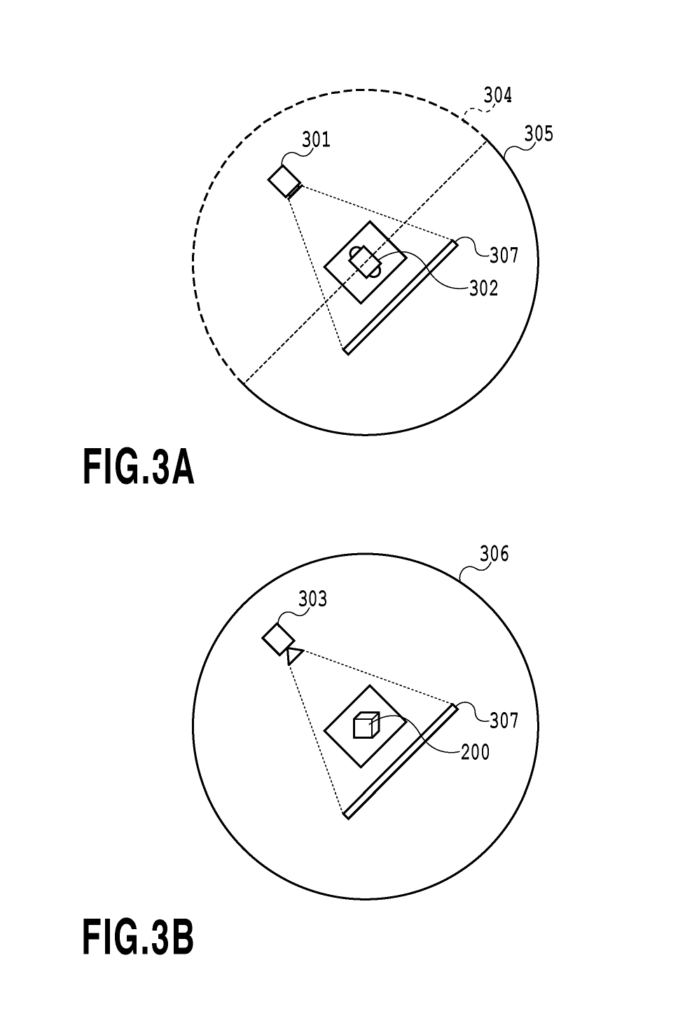

FIGS. 3A and 3B are diagrams schematically showing the photographing environment of each image shown in FIGS. 2A to 2E, wherein FIG. 3A shows an actual photographing environment and FIG. 3B shows a virtual photographing environment. Reference numeral 301 is a camera that photographs a background image 307, 302 is a camera that photographs a surrounding image, and 303 is a virtual camera that is referred to when the background image 307 and the virtual subject 200 are combined. Here, the camera 302 that photographs a surrounding image is a superwide-angle camera having an angle of view of 180° or more and installed in the same position as that of the virtual subject 200. By this camera 302, the surrounding image (corresponding to FIG. 2C) in the direction of the camera 301 indicated by a broken line 304 and a surrounding image (corresponding to FIG. 2D) indicated by a solid line 305 in the 180° opposite direction are photographed. By combining the two surrounding images 304 and 305 photographed in this manner, an environment map 306, which is a panorama image around 360° of the virtual subject 200 is generated.

Note that, the method for acquiring an environment map is not limited to this and, for example, a method for photographing at one time by using an omni-directional camera and a method for generating an environment map by combining multi-viewpoint images photographed by a camera capable of photographing from a plurality of viewpoints, such as a camera array, may be accepted. Further, it may also be possible to obtain an environment map by installing a chrome ball in the same position as that of the virtual subject 200 and by performing photographing by the camera 301.

Moreover, when making use of an environment map as alight source image in order to perform rendering of the virtual subject 200, in general, the environment map is generated as a high dynamic range image.

In the present embodiment, explanation is given below on the assumption that the photographing condition of the virtual camera 303 is set to the same photographing condition of the camera 301 that photographs the background image 307. As a matter of course, it is not necessarily necessary for the setting of the virtual camera 303 to be the same as that of the camera 301 because the setting of the virtual camera 303 can be changed arbitrarily. For example, when making use of only part of the background image 307 as a background of a combined image, the setting of the camera 301 is different from that of the virtual camera 303.

Further, images handled in the present embodiment are general RGB images and explanation is given on the assumption that the color signal value has three bands also as to image processing. However, this is not necessarily limited and images may be multi-band images. It is also possible to perform multi-band processing only for image processing.

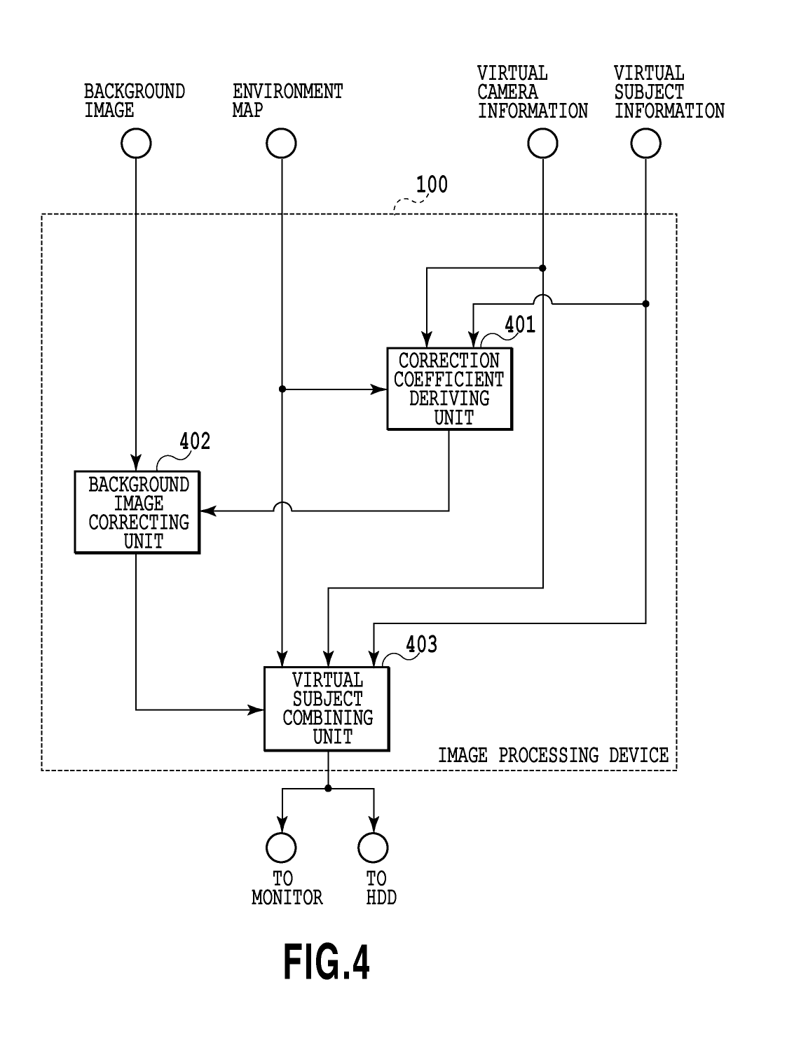

FIG. 4 is a functional configuration diagram of the image processing device according to the present embodiment. The configuration shown in FIG. 4 is realized as image processing application software. That is, the configuration is realized by causing the CPU 101 to execute various kinds of software (computer programs) stored in the HDD 103.

The image processing device 100 receives data of background image, environment map, virtual camera information, and virtual subject information as input data and through correction coefficient derivation processing and background image correction processing, outputs combined image data obtained by combining a virtual subject with the background image as output data. Here, the virtual camera information is information of a virtual camera placed in a virtual space and is information equivalent to the photographing condition of the background image, indicating information, such as three-dimensional coordinates indicating the photographing position, the angle of view of the camera, and the direction vector indicating the orientation of the camera. Further, the information may include the lens characteristic, exposure, shutter speed, etc., at the time of photographing. Moreover, the virtual subject information is information about details of the virtual subject to be combined with the background image, indicating information, such as three-dimensional coordinates indicating the position of the virtual subject, material data indicating the color and shape of the virtual subject, and the reflection/transmission characteristic of the virtual subject. The various pieces of data, such as the background image, the environment map, the virtual camera information, and the virtual subject information, is input from the image capturing device 106, the HDD 103, the external memory 108, etc., based on a user's instruction from the input device 107.

A correction coefficient deriving unit 401 derives a correction coefficient using the virtual camera information, virtual subject information, and environment map which have been input. The derived correction coefficient is stored in the RAM 102.

A background image correcting unit 402 generates a corrected background image using the input data of background image and the derived correction coefficient. Data of the generated corrected background image is stored in the RAM 102.

A virtual subject combining unit 403 generates a combined image using the environment map, virtual camera information, and virtual subject information which have been input, and the generated corrected background image. The data of the generated combined image is stored in the RAM 102 and then output to the HDD 103, the external memory 108, the monitor 109, etc., in response to a user's instruction.

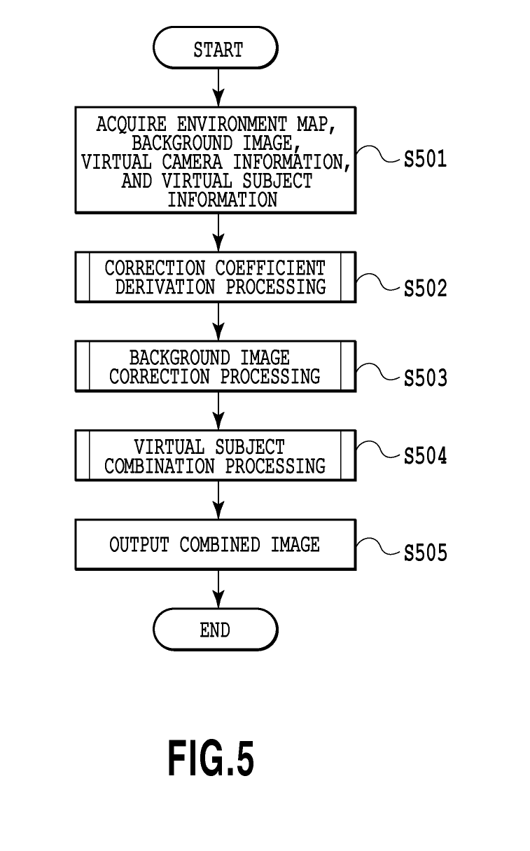

FIG. 5 is a flowchart showing a general flow of image processing performed in the image processing device 100 according to the present embodiment. In fact, after a computer-executable program in which the procedure shown below is described is read onto the RAM 102 from the HDD 103 etc., the processing is performed by the CPU 101 executing the program.

In step 501, the image processing device 100 acquires the above-mentioned input data, that is, the background image, the environment map, the virtual camera information, and the virtual subject information. Of the acquired input data, the virtual camera information, the virtual subject information, and the environment map are sent to the correction coefficient deriving unit 401 and the virtual subject combining unit 403. The background image is sent to the background image correcting unit 402.

In step 502, the correction coefficient deriving unit 401 derives a correction coefficient used in background image correction processing based on the environment map, the virtual camera information, and the virtual subject information. Details of the correction coefficient derivation processing will be described later.

In step 503, the background image correcting unit 402 corrects the background image using the background image and the correction coefficient derived in step 502 and generates a corrected background image. Details of the background image correction processing will also be described later.

In step 504, the virtual subject combining unit 403 performs processing to combine the virtual subject and the background image (virtual subject combination processing) based on the generated corrected background image and the acquired environment map, virtual camera information, and virtual subject information and generates a combined image. Details of the virtual subject combination processing will also be described later.

In step 505, the image processing device 100 outputs data of the combined image generated in step 504.

The above is the outline of the image processing in the image processing device 100 according to the present embodiment.

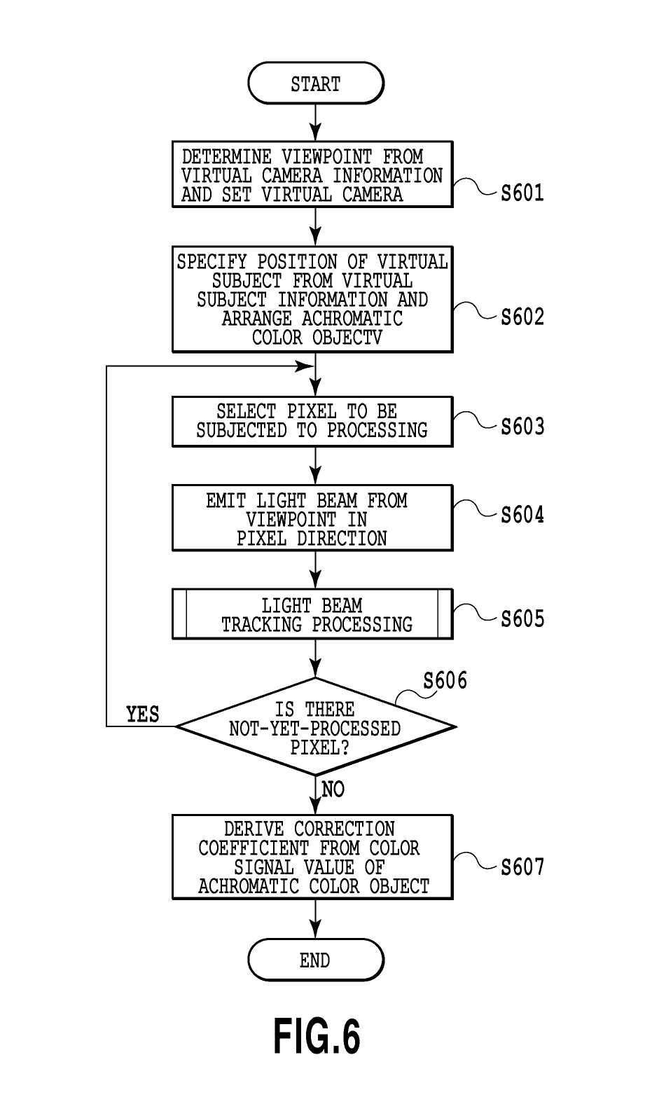

(Correction coefficient derivation processing) FIG. 6 is a flowchart showing details of the correction coefficient derivation processing in step 502 in FIG. 5.

In step 601, the correction coefficient deriving unit 401 determines a viewpoint from the virtual camera information acquired in step 501 and sets a photographing position of the virtual camera. As described above, the virtual camera information includes information of three-dimensional coordinates indicating the photographing position of the background image and the direction vector indicating the orientation of the camera. Therefore, the position specified by the information is determined as a viewpoint and the position of the determined viewpoint is set as the photographing position of the virtual camera.

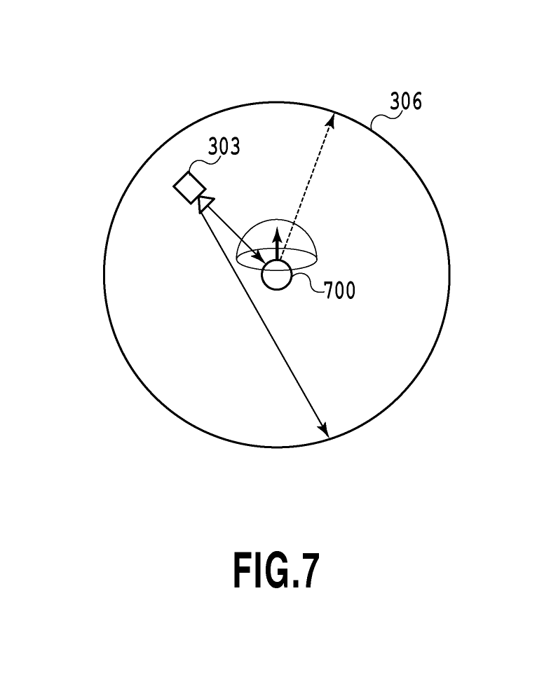

In step 602, the correction coefficient deriving unit 401 specifies the set position of the virtual subject from the acquired virtual subject information and arranges an achromatic color object in the specified position. FIG. 7 is a diagram showing the way an achromatic color object is arranged. In FIG. 7, reference numeral 700 is a virtual white ball arranged in the same position as that of the virtual subject as an achromatic color three-dimensional CG object. Here, as an achromatic color object, a white ball is used, but the object is not necessarily a white ball. Further, an achromatic color is preferable because it is only necessary to acquire white balance of light with which the virtual subject is irradiated through the environment map, but a chromatic color the color signal value of which is already known may be accepted. Furthermore, as to the shape also, by adopting a sphere, it is possible to acquire information in view of light in a wider range, but the shape is not necessarily limited to a sphere. As to the size also, a size substantially the same as that of the virtual subject is preferable, but this is not limited in particular.

In step 603, the correction coefficient deriving unit 401 selects a pixel to be subjected to processing for which rendering of the white ball viewed from the virtual camera is performed. Note that, as to an image to be subjected to rendering, there are no restrictions in particular, but the larger the number of pixels, the more accurate light information can be acquired. Further, as to the method for selecting a pixel, there are no restrictions in particular and for example, it is recommended to select pixels sequentially from the top-left of the image toward the bottom-right.

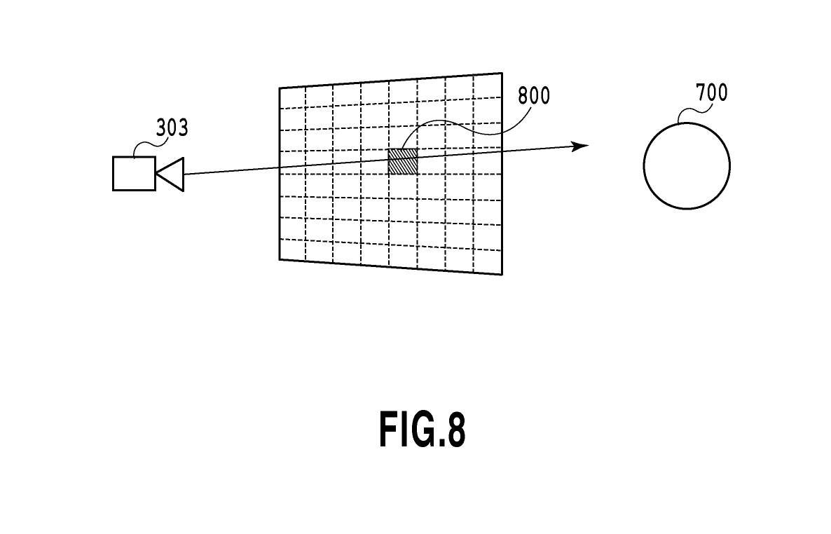

In step 604, the correction coefficient deriving unit 401 emits a light beam in the direction of a selected pixel from the viewpoint (set position of the virtual camera) determined in step 601. FIG. 8 is a diagram showing the way a light beam is emitted from the virtual camera 303 in the direction of a selected pixel. In FIG. 8, reference numeral 800 indicates a selected pixel. By emitting a light beam toward the selected pixel 800 from the set position of the virtual camera as described above, the orientation of the light beam is determined.

In step 605, the correction coefficient deriving unit 401 acquires the color signal value of the selected pixel, that is, the color signal value at the intersection of the emitted light beam and the achromatic color object by light beam tracking processing to be described below. The light beam tracking processing is performed by a light beam tracking processing unit (not shown schematically) within the correction coefficient deriving unit 401.

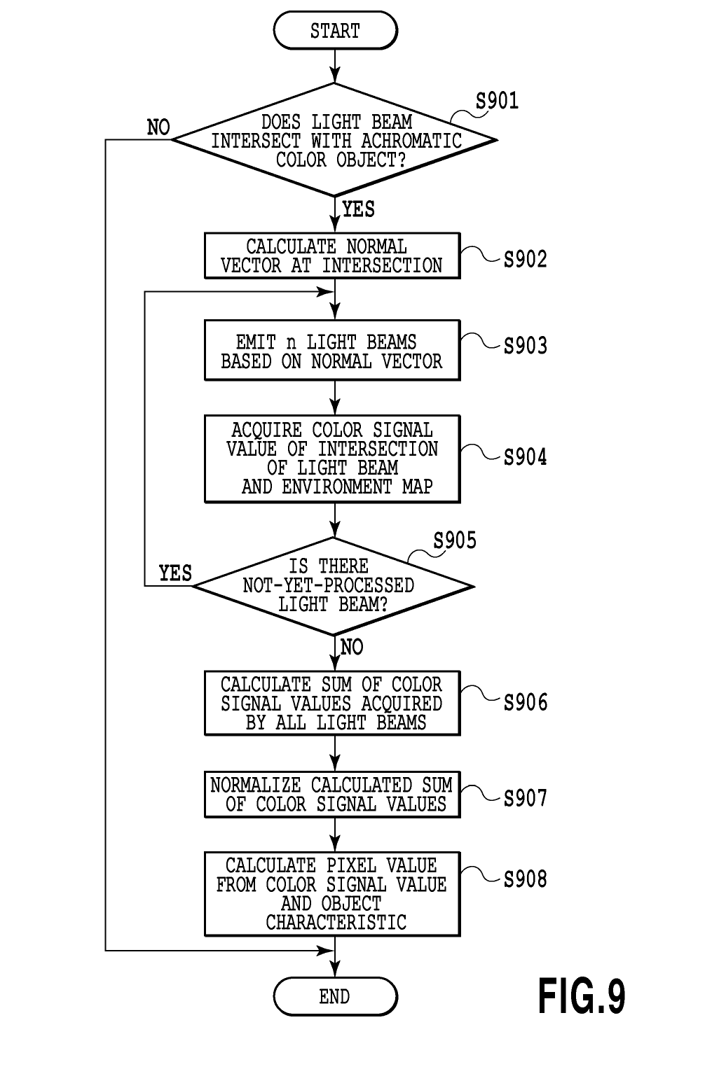

FIG. 9 is a flowchart showing details of light beam tracking processing.

In step 901, the light beam tracking processing unit determines whether the light beam emitted from the virtual camera 303 intersects with the achromatic color object (white ball). When it is determined that the light beam intersects with the object, the procedure proceeds to step 902. On the other hand, when it is determined that the light beam does not intersect with the object, the light beam tracking processing is exited.

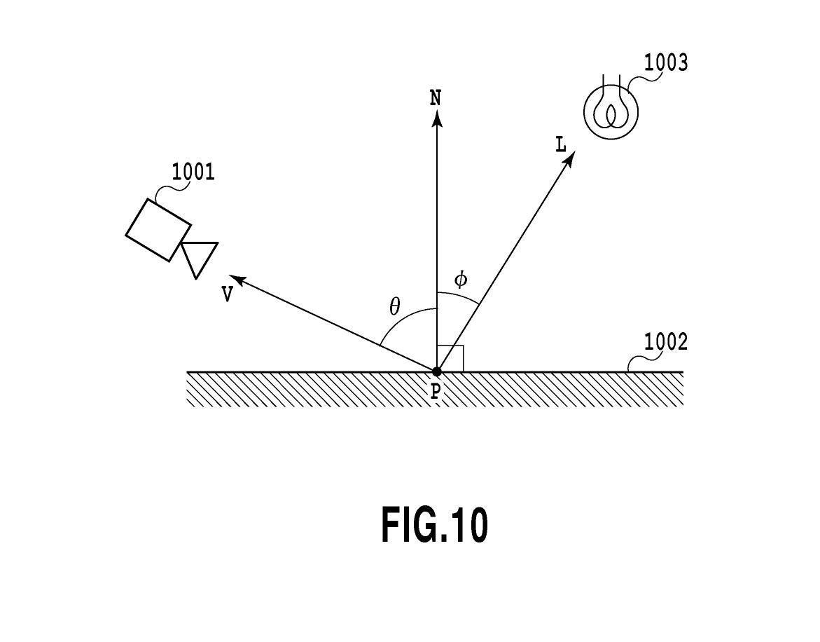

In step 902, the light beam tracking processing unit finds a normal vector at the intersection of the emitted light beam and the achromatic color object. FIG. 10 is a diagram showing a relationship between an emitted light beam and an achromatic color object. In FIG. 10, reference numeral 1001 is the position of the virtual camera 303 (viewpoint from which a light beam is emitted), 1002 is the surface of the achromatic color object with which the emitted light beam intersects, and 1003 is a light source that illuminates the achromatic color object. Then, reference symbol P indicates the intersection of the light beam and the achromatic color object, V indicates the direction vector from the intersection P to the viewpoint 1001, and L indicates the direction vector from the intersection P to the light source 1003. Then, N is the normal vector to be found, which is the vector perpendicular to the surface 1002 of the achromatic color object at the intersection P.

In step 903, the light beam tracking processing unit emits a light beam from the intersection P toward the light source 1003 based on the normal vector N that is found. In general, the larger the number of light beams emitted from the intersection P, the more accurate color signal value of a pixel can be acquired. Further, the direction of the light beam to be emitted is determined in a range in which an angle φ formed by the normal vector N and the direction vector L is less than 90°. Consequently, the normal vector N and the direction vector L satisfy Expression below.

[Formula 1]

N·L>0.0 Expression (1)

Note that, the light source 1003 of FIG. 10 in the present embodiment is the environment map shown by reference numeral 306 of FIG. 7 and the setting is done around 360° of the achromatic color object, and therefore, it is possible to emit a light beam in a desired direction in the range that satisfies the condition of Expression (1). For example, it is possible to emit a light beam by equally dividing the range that satisfies Expression (1) or to emit a light beam randomly. Hereinafter, in the present embodiment, explanation is given on the assumption that n light beams are emitted randomly.

In step 904, the light beam tracking processing unit acquires the color signal value of the intersection of the emitted light and the light source (environment map).

In step 905, the light beam tracking processing unit determines whether there is a not-yet-processed light beam. When the processing of all the n light beams is completed, the procedure proceeds to step 906. On the other hand, when there is a not-yet-processed light beam, the procedure returns to step 903 and the next light beam is emitted.

In step 906, the light beam tracking processing unit calculates the sum of the color signal values acquired by the n light beams. Sums (E_{R}, E_{G}, E_{B}) for each component of the color signal values (rᵢ, gᵢ, bᵢ) acquired by the n light beams will be those as expressed by Expressions (2) to (4), respectively.

$$\begin{matrix}[ Formula 2 ] & \\ {E}_{R} = {\sum }_{i = 1}^{n} {r}_{i} & Expression ( 2 ) \\ [ Formula 3 ] & \\ {E}_{G} = {\sum }_{i = 1}^{n} {g}_{i} & Expression ( 3 ) \\ [ Formula 4 ] & \\ {E}_{B} = {\sum }_{i = 1}^{n} {b}_{i} & Expression ( 4 )\end{matrix}$$

In step 907, the light beam tracking processing unit normalizes the calculated sums (E_{R}, E_{G}, E_{B}) for each component of the color signal values. This is done to prevent trouble caused by the difference in the number of light beams calculated for each pixel and by restrictions of the output range (for example, in the case of eight bits, 256 gradations for each component of RGB). In the present embodiment, by Expressions (5) to (7) below, color signal values (E′_{R}, E′_{G}, E′_{B}) after normalization are obtained.

$$\begin{matrix}[ Formula 5 ] & \\ {E}_{R}^{′} = \frac{{E}_{R}}{n} & Expression ( 5 ) \\ [ Formula 6 ] & \\ {E}_{G}^{′} = \frac{{E}_{G}}{n} & Expression ( 6 ) \\ [ Formula 7 ] & \\ {E}_{B}^{′} = \frac{{E}_{B}}{n} & Expression ( 7 )\end{matrix}$$

Note that, a desired method may be used for normalization of the color signal value. Further, when no trouble is caused even if normalization is not performed, it may also be possible to omit the present step.

In step 908, the light beam tracking processing unit acquires the pixel value based on the normalized color signal value and the characteristic of the achromatic color object. Here, the color signal value obtained by normalization can be thought to be light energy with which the intersection P on the achromatic color object in FIG. 10 is irradiated and the reflection characteristic of the achromatic color object. Consequently, by multiplying the color signal value obtained by the normalization in step 907 and the color signal value of the achromatic color object, the light energy reflected in the direction of the viewpoint 1001, that is, the pixel value is obtained. Therefore, if it is assumed that the color signal values at the intersection P of FIG. 10 are (r_{R}, r_{G}, r_{E}) and the maximum value of each color signal is 255 (eight bits), color signal values [R, G, B] of the pixel is obtained by Expressions (8) to (10) below as a result.

$$\begin{matrix}[ Formula 8 ] & \\ {R}_{x , y} = \frac{{r}_{R} \times {E}_{R}^{′}}{255} & Expression ( 8 ) \\ [ Formula 9 ] & \\ {G}_{x , y} = \frac{{r}_{G} \times {E}_{G}^{′}}{255} & Expression ( 9 ) \\ [ Formula 10 ] & \\ {B}_{x , y} = \frac{{r}_{B} \times {E}_{B}^{′}}{255} & Expression ( 10 )\end{matrix}$$

In Expressions (8) to (10) described above, “x, y” represent the coordinates of the pixel. In the case of a chromatic color object, Expressions (8) to (10) are applied after the color signal values are corrected so that the ratio between the color signal values (r_{R}, r_{G}, r_{E}) at the intersection P is 1:1:1.

Furthermore, the characteristic of the achromatic color object used to acquire the pixel value is not limited to the color signal value and for example, the variable angle spectral reflectance etc. may be used. The variable angle spectral reflectance is determined in accordance with the incidence angle of light on an object and reflection angle and if the variable angle spectral reflectance does not depend on the incidence angle or the reflection angle, the variable angle spectral reflectance is the spectral reflectance. If it is assumed that an incidence angle of light on the intersection P on the object in a certain section is φ and a reflection angle is θ (see FIG. 10), the variable angle spectral reflectance is represented by r_{R} (φ, θ), r_{G}(φ, θ), and r_{B} (φ, θ). Consequently, the color signal values [R, G, B] to be found are obtained by Expressions (11) to (13) below.

[Formula 11]

R_{x,y}=r_{R}(φ,θ)×E′_{R} Expression (11)

[Formula 12]

G_{x,y}=r_{G}(φ,θ)×E′_{G} Expression (12)

[Formula 13]

B_{x,y}=r_{B}(φ,θ)×E′_{B} Expression (13)

Here, an example of the variable angle spectral reflectance in a certain section is explained, but it may also be possible to provide the variable angle spectral reflectance with the four-dimensional variable angles as parameters without limiting the plane.

Explanation is returned to the flowchart of FIG. 6.

In step 606, the correction coefficient deriving unit 401 determines whether the light beam tracking processing of all the pixels is completed. When not completed, the procedure returns to step 603 and the pixel to be processed next is selected. On the other hand, when completed, the procedure proceeds to step 607.

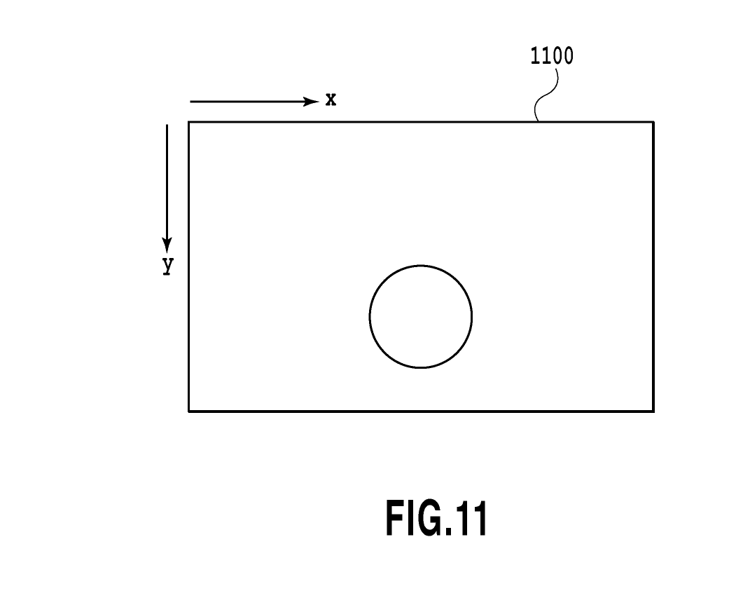

In step 607, correction coefficients are derived from the pixel values (color signal values of the achromatic color object) acquired by the light beam tracking processing. FIG. 11 is a diagram showing the rendering result (rendering image) of the white ball generated through each processing of steps 603 to 605. In a rendering image 1100, the pixel values of the region other than the white ball are not acquired, and therefore, it is possible to easily extract only the region of the white ball. Correction coefficients are required only to be values with which the white balance of the color signal values of the white ball can be corrected. For example, if it is assumed that the color signal values of each pixel of the white ball in the rendering image 1100 are (r_{x, y}, g_{x, y}, b_{x, y}), correction coefficients (t_{R}, t_{G}, t_{B}) of each color component with Gas a reference are those expressed by Expressions (14) to (16) below.

$$\begin{matrix}[ Formula 14 ] & \\ {t}_{R} = \frac{{\sum }_{x} {\sum }_{y} {r}_{x , y}}{{\sum }_{x} {\sum }_{y} {g}_{x , y}} & Expression ( 14 ) \\ [ Formula 15 ] & \\ {t}_{G} = 1.0 & Expression ( 15 ) \\ [ Formula 16 ] & \\ {t}_{B} = \frac{{\sum }_{x} {\sum }_{y} {b}_{x , y}}{{\sum }_{x} {\sum }_{y} {g}_{x , y}} & Expression ( 16 )\end{matrix}$$

In this manner, the correction coefficient of the background image is derived.

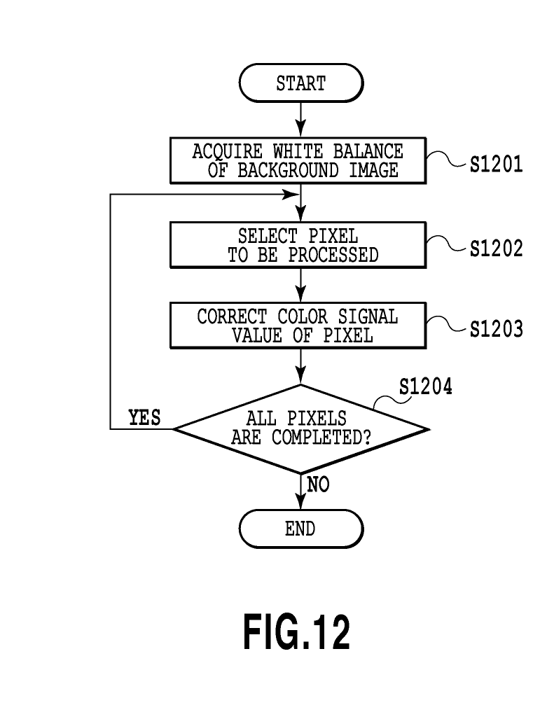

(Background image correction processing) FIG. 12 is a flowchart showing details of background image correction processing in step 503 of FIG. 5.

In step 1201, the background image correcting unit 402 acquires the white balance of the background image acquired in step 501. Any method may be used as a method for acquiring white balance. For example, there are publicly-known estimating methods, such as a method for acquiring white balance from information described on the tag of the background image, a method for specifying the point that is white within the background image by UI, and a method for using the brightest color in the background image as white.

In step 1202, the background image correcting unit 402 selects pixels to be subjected to correction processing from the background image. The method for selecting pixels to be subjected to the correction processing is not limited in particular and it is recommended to select pixels sequentially, for example, from the top-left of the image toward the bottom-right.

In step 1203, the background image correcting unit 402 corrects the color signal value of the selected pixel using the correction coefficient obtained by the correction coefficient derivation processing. Here, it is assumed that the color signal values of the selected pixel are (R_{b}, G_{b}, B_{b}), the derived correction coefficients are (t_{R}, t_{G}, t_{B}), and the ratios of the color signal values obtained from the white balance are (u_{R}, u_{G}, u_{B}). Then, color signal values (R′_{b}, G′_{b}, B′_{b}) after the correction are represented by Expressions (17) to (19) below.

$$\begin{matrix}[ Formula 17 ] & \\ {R}_{b}^{′} = \frac{{t}_{R} \times {R}_{b}}{{u}_{R}} & Expression ( 17 ) \\ [ Formula 18 ] & \\ {G}_{b}^{′} = \frac{{t}_{G} \times {G}_{b}}{{u}_{G}} & Expression ( 18 ) \\ [ Formula 19 ] & \\ {B}_{b}^{′} = \frac{{t}_{B} \times {B}_{b}}{{u}_{B}} & Expression ( 19 )\end{matrix}$$

Here, for example, it is assumed that the color signal values of the selected pixel are (128, 128, 128), the derived correction coefficients are (1.067, 1.0, 1.069), and the ratios of the color signal values obtained from the white balance are (1.053, 1.0, 0.96). In this case, the color signal values after the correction obtained in the present step are (130, 128, 143) from Expressions (17) to (19).

In step 1204, the background image correcting unit 402 determines whether the correction processing is completed for all the pixels of the background image. When completed, the present processing is terminated. On the other hand, when there is a not-yet-processed pixel, the procedure returns to step 1202 and the next pixel is selected.

By the above processing, the background image is corrected based on the white balance of light with which the virtual subject is irradiated through the environment map.

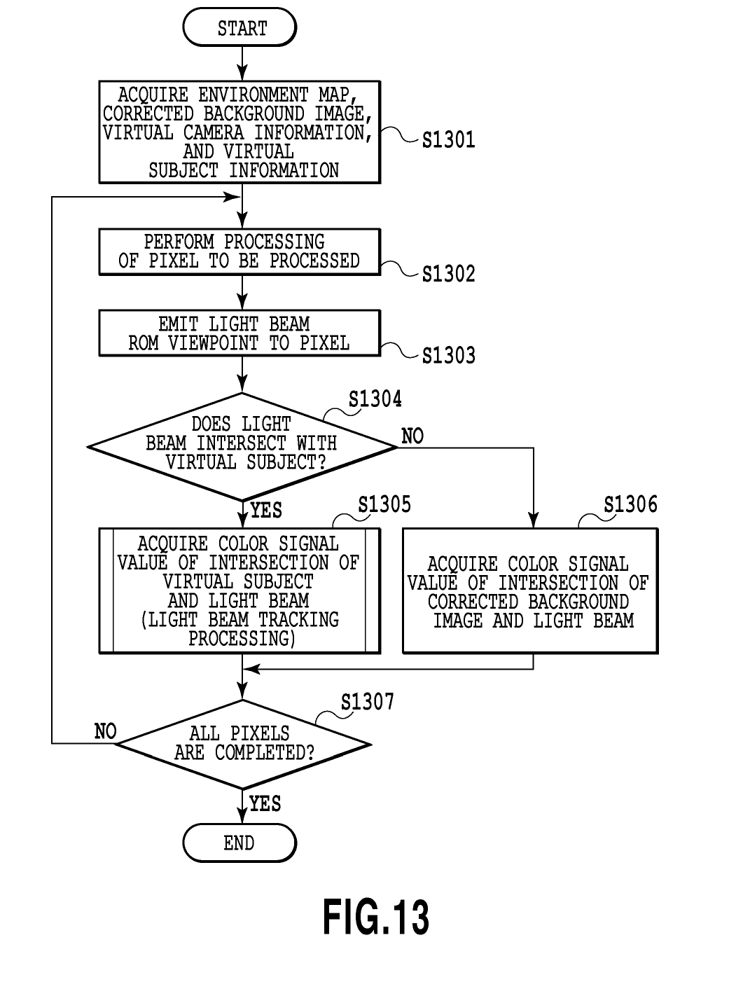

(Virtual subject combination processing) FIG. 13 is a flowchart showing details of virtual subject combination processing in step 504 of FIG. 5.

In step 1301, the virtual subject combining unit 403 acquires the environment map, the virtual camera information, and the virtual subject information acquired in step 501 and the corrected background image generated in step 503.

In step 1302, the virtual subject combining unit 403 selects pixels to be subjected to the processing to acquire the color signal value from the corrected background image. The pixel selection method is not limited in particular and for example, it is recommended to select pixels sequentially from the top-left of the corrected background image toward the bottom-right.

In step 1303, the virtual subject combining unit 403 emits a light beam from the viewpoint position specified in the virtual camera information acquired in step 1301 toward the selected pixel.

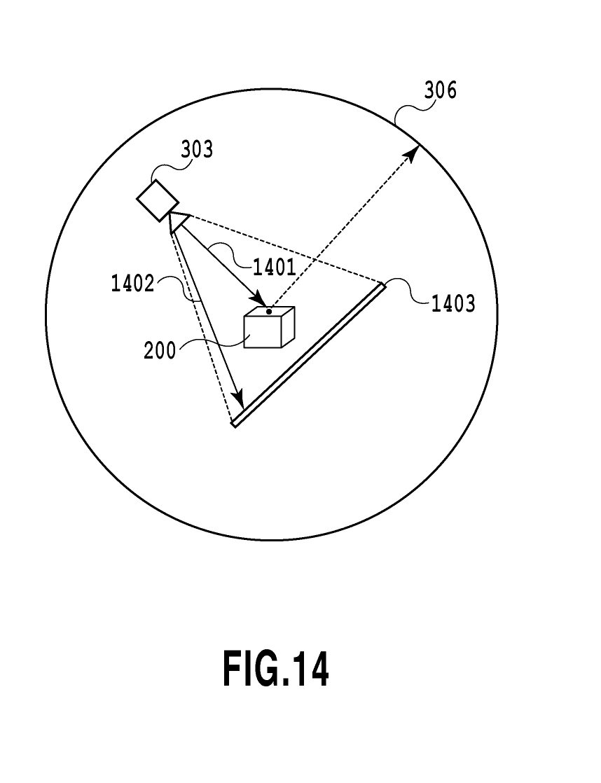

In step 1304, the virtual subject combining unit 403 determines whether or not the emitted light beam intersects with the virtual subject. When it is determined that the emitted light beam intersects therewith, the procedure proceeds to step 1305 and when it is determined that the beam does not intersect, the procedure proceeds to step 1306. FIG. 14 is a diagram visually showing a case where the emitted light beam intersects with the virtual subject and a case where not. In FIG. 14, reference numeral 200 is the virtual subject set based on the virtual subject information and 303 is the virtual camera set based on the virtual camera information. Reference numeral 1403 is a corrected background image set based on information of angle of view included in the virtual camera information and 306 is the environment map. Then, 1401 and 1402 represent emitted light beams and the light beam. 1401 intersects with the virtual subject 200 and the light beam 1402 does not intersect with the virtual subject 200 but intersects with the corrected background image 1403. In this case, as to the light beam 1401, rendering is performed using the environment map 306 as a light source. Note that, the corrected background image 1403 is set in accordance with the angle of view of the virtual camera 303, and therefore, the emitted light beam intersects with the virtual subject 200 or the corrected background image 1403 without exception.

In step 1305, the virtual subject combining unit 403 acquires the color signal value of the selected pixel, in this case, the color signal value at the intersection of the virtual subject and the light beam. In the light beam tracking processing in the present step, the “achromatic color object” is only replaced with the “virtual subject” in the light beam tracking processing within the previously-described correction coefficient derivation processing and the contents are the same, and therefore, details are omitted.

In step 1306, the virtual subject combining unit 403 acquires the color signal value at the intersection of the corrected background image acquired in step 1301 and the light beam emitted in step 1303.

In step 1307, the virtual subject combining unit 403 determines whether the processing is completed for all the pixels of the corrected background image. When completed, the present processing is terminated. On the other hand, when there is a not-yet-processed pixel, the procedure returns to step 1302 and the next pixel is selected.

In this manner, the corrected background image and the virtual subject are combined and a combined image is generated.

As above, according to the present embodiment, in the processing to generate a combined image of an actually photographed background image and a virtual subject, by correcting the background image based on the white balance of light with which the virtual subject is irradiated through the environment map, it is made possible to automatically generate a natural combined image. Due to this, adjustment of parameters by trial and error is no longer necessary.

### Second Embodiment

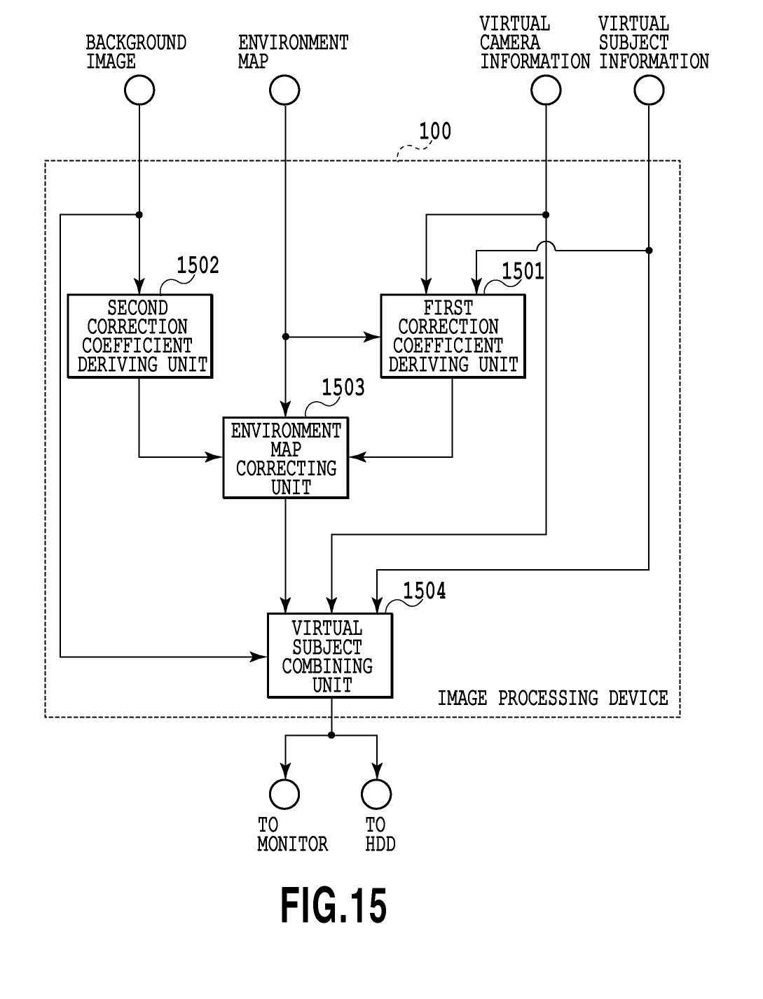

In the first embodiment, an aspect is explained, in which the background image is corrected based on the white balance of light with which the virtual subject is irradiated through the environment map. Next, an aspect is explained as a second embodiment, in which the environment map, not the background image, is corrected based on the white balance of the background image. Note that, explanation of parts common to those of the first embodiment is simplified or omitted and different points are explained mainly. FIG. 15 is a functional configuration diagram of an image processing device according to the present embodiment. The configuration shown in FIG. 15 is realized as image processing application software.

A first correction coefficient deriving unit 1501 derives a first correction coefficient using the input virtual camera information, virtual subject information, and environment map. The derived first correction coefficient is stored in the RAM 102.

A second correction coefficient deriving unit 1502 derives a second correction coefficient from the data of the input background image. The derived second correction coefficient is stored in the RAM 102.

An environment map correcting unit 1503 corrects the environment map using the data of the input environment map and the derived first correction coefficient and second correction coefficient and generates a corrected environment map. The generated corrected environment map is stored in the RAM 102.

A virtual subject combining unit 1504 generates a combined image using the input background image, virtual camera information, and virtual subject information and the generated corrected environment map. The data of the generated combined image is stored in the RAM 102.

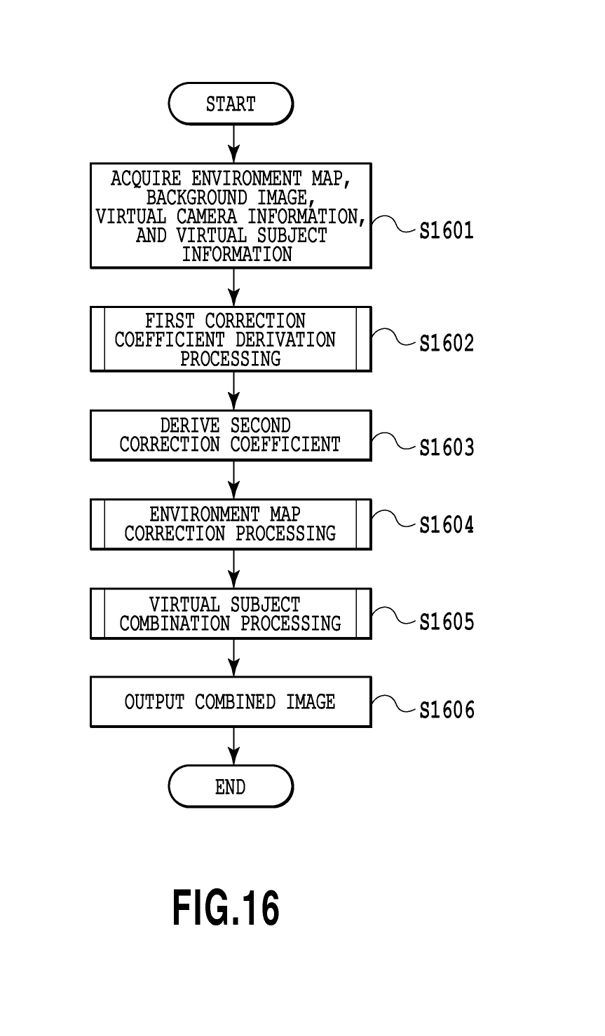

FIG. 16 is a flowchart showing a general flow of image processing performed in the image processing device 100 according to the present embodiment.

In step 1601, the image processing device 100 acquires a background image, environment map, virtual camera information, and virtual subject information. The virtual camera information and the virtual subject information of the acquired input data are sent to the first correction coefficient deriving unit 1501 and the virtual subject combining unit 1504. The background image is sent to the second correction coefficient deriving unit 1502 and the virtual subject combining unit 1504. The environment map is sent to the first correction coefficient deriving unit 1501 and the environment map correcting unit 1503.

In step 1602, the first correction coefficient deriving unit 1501 derives the first correction coefficient used in environment map correction processing based on the environment map, the virtual camera information, and the virtual subject information. It should be noted that the first correction coefficient is the same as the correction coefficient derived in the correction coefficient derivation processing in the first embodiment and the contents of the derivation processing are the same as those of the flowchart of FIG. 6 according to the first embodiment, and therefore, explanation here is omitted.

In step 1603, the second correction coefficient deriving unit 1502 derives the second correction coefficient based on the background image. Note that, the second correction coefficient is a coefficient based on the white balance of the background image. Consequently, first, the white balance of the background image is acquired. The white balance acquisition method is the same as that of step 1201 of the flowchart of FIG. 12 according to the first embodiment. If it is assumed that the color signal values of white based on the acquired white balance are (w_{R}, w_{G}, w_{B}) and G is taken as a reference, the second correction coefficients (u_{R}, u_{G}, u_{B}) are as those expressed by Expressions (20) to (22) below.

$$\begin{matrix}[ Formula 20 ] & \\ {u}_{R} = \frac{{w}_{R}}{{w}_{G}} & Expression ( 20 ) \\ [ Formula 21 ] & \\ {u}_{G} = 1.0 & Expression ( 21 ) \\ [ Formula 22 ] & \\ {u}_{B} = \frac{{w}_{R}}{{w}_{G}} & Expression ( 22 )\end{matrix}$$

Note that, the second correction coefficient is only required to provide the ratio of each color signal value of R, G, B based on the white balance of the background image, and therefore, the derivation method is not limited to that explained in the present embodiment.

In step 1604, the environment map correcting unit 1503 corrects the environment map based on the first correction coefficient derived in step 1602 and the second correction coefficient derived in step 1603. Details of the environment map correction processing will be described later.

In step 1605, the virtual subject combining unit 1504 performs virtual subject combination processing based on the corrected environment map generated in step 1604 and the background image, the virtual camera information, and the virtual subject information acquired in step 1601 and generates a combined image. It should be noted that the contents of the virtual subject combination processing are the same as those of the flowchart of FIG. 13 according to the first embodiment, and therefore, explanation here is omitted.

In step 1606, the image processing device 100 outputs the data of the combined image generated in step 1605.

The above is an outline of the image processing in the image processing device 100 according to the present embodiment.

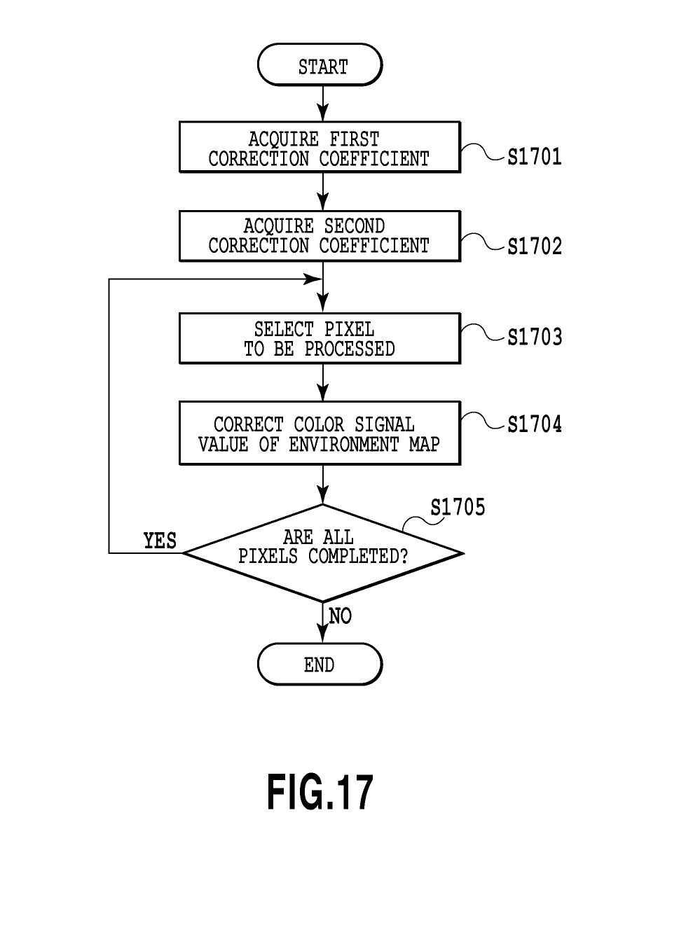

(Environment map correction processing) FIG. 17 is a flowchart showing details of the environment map correction processing in step 1604 of FIG. 16.

In step 1701, the environment map correcting unit 1503 acquires the first correction coefficient derived in step 1602 of FIG. 16.

In step 1702, the environment map correcting unit 1503 acquires the second correction coefficient derived in step 1603 of FIG. 16.

In step 1703, the environment map correcting unit 1503 selects pixels to be subjected to the correction processing from the environment map. The method for selecting pixels to be subjected to the correction processing is not limited in particular and for example, it is recommended to select pixels sequentially from the top-left of the image toward the bottom-right.

In step 1704, the environment map correcting unit 1503 corrects the color signal value of the selected pixel using the above-mentioned first correction coefficient and second correction coefficient. In this case, if it is assumed that the color signal values of the selected pixel are (R_{c}, G_{c}, B_{c}), the first correction coefficients are (t_{R}, t_{G}, t_{B}), and the second correction coefficients are (u_{R}, u_{G}, u_{B}), color signal values (R′_{c}, G′_{c}, B′_{c}) after the correction are expressed by Expressions (23) to (25) below.

$$\begin{matrix}[ Formula 23 ] & \\ {R}_{c}^{′} = \frac{{u}_{R} \times {R}_{c}}{{t}_{R}} & Expression ( 23 ) \\ [ Formula 24 ] & \\ {G}_{c}^{′} = \frac{{u}_{G} \times {G}_{c}}{{t}_{G}} & Expression ( 24 ) \\ [ Formula 25 ] & \\ {B}_{c}^{′} = \frac{{u}_{B} \times {B}_{c}}{{t}_{B}} & Expression ( 25 )\end{matrix}$$

In step 1705, the environment map correcting unit 1503 determines whether the correction processing is completed for all the pixels of the environment map. When completed, the present processing is terminated. On the other hand, when there is a not-yet-processed pixel, the procedure returns to step 1703 and the next pixel is selected.

By the above processing, the environment map is corrected based on the white balance of the background image and the corrected environment map is generated.

As above, according to the present embodiment also, by correcting the environment map based on the white balance of the background image in the processing to generate the combined image of the actually photographed background image and the virtual subject, it is made possible to automatically generate a natural combined image.

### Third Embodiment

In the first and second embodiments, an aspect is explained, in which the difference in hue between light with which the virtual subject is irradiated and the background image is corrected. Next, an aspect is explained as a third embodiment, in which the difference in brightness, not in hue, is corrected.

In photographing an actually photographed image used as a background, in general, photographing is performed with appropriate exposure by placing a gray plate (standard reflecting plate) having a predetermined reflectance as a subject. Consequently, it is necessary to determine exposure using a standard reflecting plate also in CG, but the standard reflecting plate and the virtual subject are different in shape and shading appears different. That is, the exposure set by the standard reflecting plate is not necessarily appropriate for the virtual subject. Therefore, in the present embodiment, by applying the reflection characteristic of the standard reflecting plate to the shape of the virtual subject, the brightness of the virtual subject is made the same as the brightness of the background image.

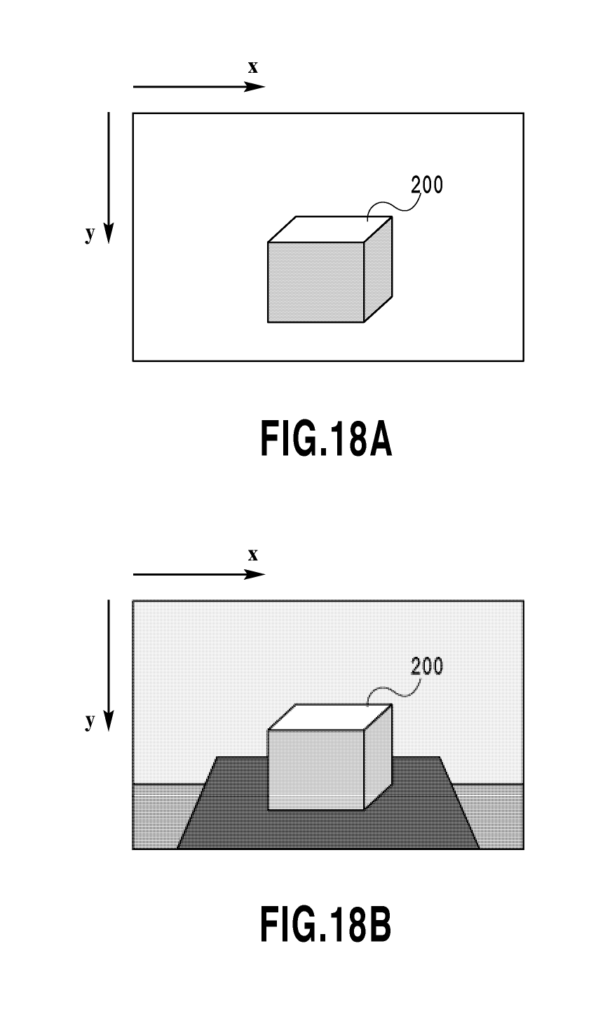

Before details of the present embodiment are explained, the effect thereof is explained first. For example, it is assumed that the virtual subject 200 shown in FIG. 14 described previously is a black body. In this case, if the virtual light is too strong or parameters relating to exposure of the virtual camera 300 are not appropriate, an image in which the body were as if a white body is generated (see FIG. 18A). Then, if such an image is combined with a background image with appropriate exposure, an unnatural combined image is obtained, in which the brightness is different between the actually photographed background and the virtual subject 200 (see FIG. 18B). Consequently, in the present embodiment, the virtual subject is corrected so as to have appropriate exposure.

Note that, explanation of parts common to those of the first and second embodiments is simplified or omitted and different points are explained mainly.

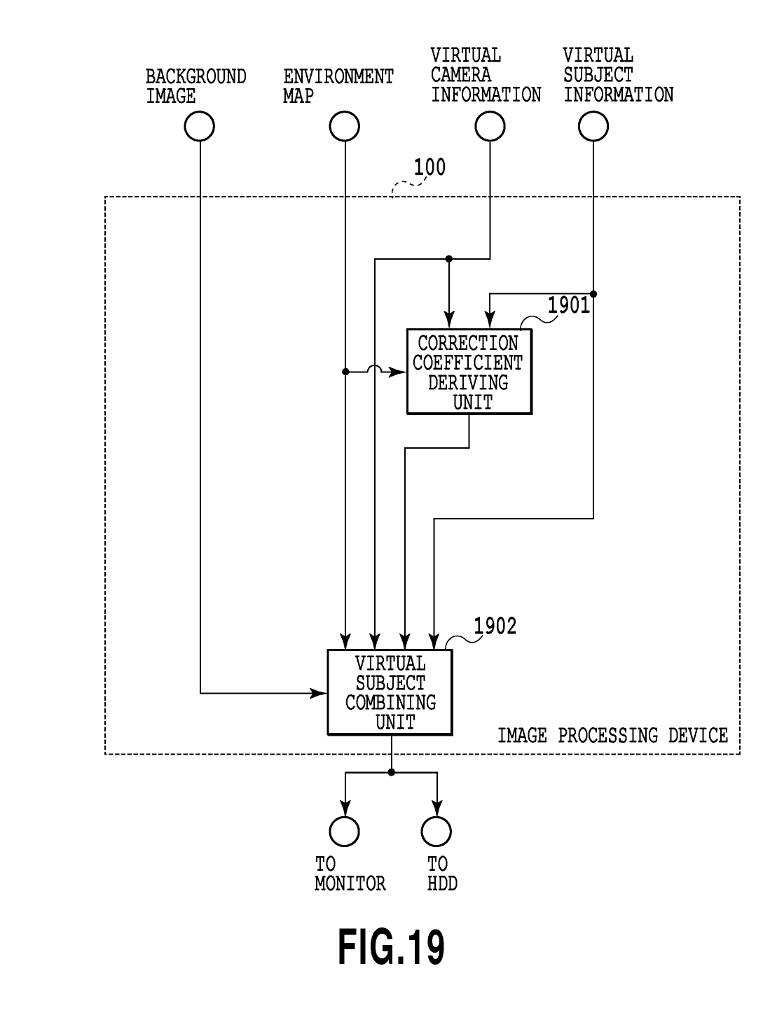

FIG. 19 is a functional configuration diagram of the image processing device according to the present embodiment. The configuration shown in FIG. 19 is realized as image processing application software.

A correction coefficient deriving unit 1901 derives a correction coefficient α using the input virtual camera information, virtual subject information, and environment map. The derived correction coefficient α is stored in the RAM 102.

A virtual subject combining unit 1902 generates a combined image using the input background image, virtual camera information, virtual subject information, and environment map, and the derived correction coefficient α. The data of the generated combined image is stored in the RAM 102 and then, output to the HDD 103, the external memory 108, the monitor 109, etc., in response to a user's instruction.

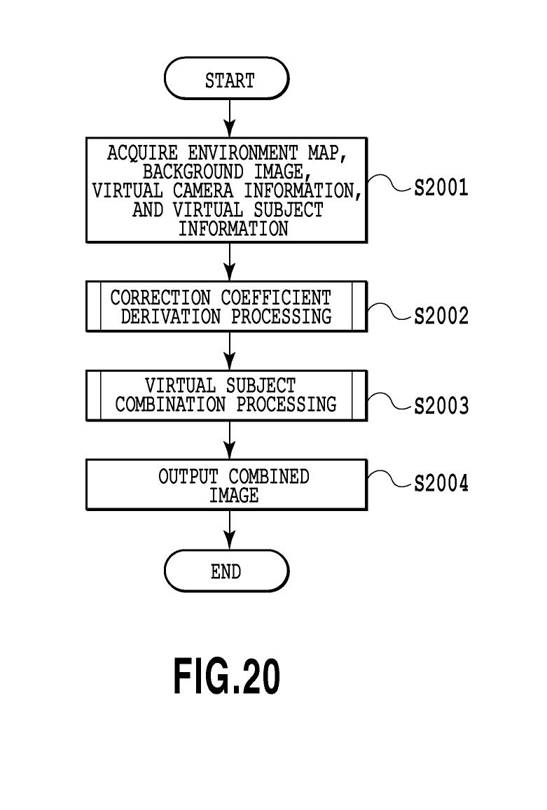

FIG. 20 is flowchart showing a general flow of image processing performed in the image processing device 100 according to the present embodiment.

In step 2001, the image processing device 100 acquires the above-mentioned input data, that is, the background image, the environment map, the virtual camera information, and the virtual subject information. The background image of the acquired input data is sent only to the virtual subject combining unit 1902 and the virtual camera information, the virtual subject information, and the environment map are sent to the correction coefficient deriving unit 1901 and the virtual subject combining unit 1902.

In step 2002, the correction coefficient deriving unit 1901 derives the correction coefficient α used in color signal value correction processing, to be described later, based on the environment map, the virtual camera information, and the virtual subject information. Here, the correction coefficient α is a coefficient based on the color signal value on the assumption that the virtual subject is a virtual standard reflecting material.

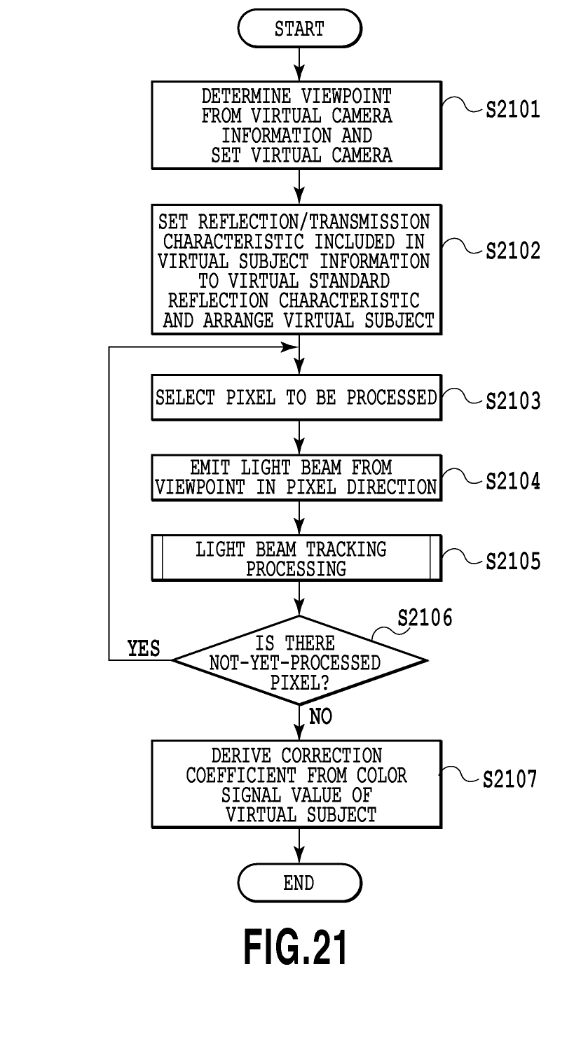

FIG. 21 is a flowchart showing a flow of correction coefficient derivation processing in the present step.

In step 2101, the correction coefficient deriving unit 1901 determines a viewpoint from the virtual camera information acquired in step 2001 and sets a photographing position of the virtual camera.

In step 2102, the correction coefficient deriving unit 1901 sets the reflection/transmission characteristic included in the virtual subject information acquired in step 2001 as the virtual standard reflection characteristic (replaces the reflection/transmission characteristic with the virtual standard reflection characteristic) and arranges the virtual subject the reflectance of which is set to the virtual standard reflectance in a predetermined position. Here, it is assumed that, the virtual standard reflection characteristic (virtual standard reflectance) is the perfect diffuse reflection characteristic, that is, the brightness of a surface viewed from an observer when light incident on the surface is scattered is the same regardless of the angle of the viewpoint of the observer. As the virtual standard reflectance, an arbitrary value is set, which is determined in advance to define appropriate exposure of the camera. In this point, the appropriate exposure of a general camera used when capturing an actually-photographed image is designed so that the pixel value of the subject having a reflectance of 18% in the gray scale is D/2 (D: the maximum pixel value that is recordable). Therefore, in case where the background image is properly exposed, D is identical to a maximum pixel value that is recordable as the background image. Consequently, in the present embodiment, it is assumed that the reflection/transmission characteristic included in the virtual subject information is replaced with 18% in order to match the exposure condition of the virtual camera with the above-mentioned design. Specifically, the coefficients (r_{R}, r_{G}, r_{B}) in Expressions (8) to (10) used in light beam tracking processing, to be described later, are set to r_{R}=r_{G}=r_{B}=0.18×255. In this case, the reason for the multiplication by 255 is that (r_{R}, r_{G}, r_{B}) respectively represent the color signal value at the intersection of the light beam and the virtual subject in the range of 0 to 255.

Steps 2103 to 2105 are the same as steps 603 to 605 of the flowchart of FIG. 6 according to the first embodiment. That is, the correction coefficient deriving unit 1901 selects a pixel to be subjected to rendering processing (S2103), emits a light beam in the direction of the selected pixel (S2104), and acquires the color signal value of the intersection of the emitted light beam and the virtual subject by the light beam tracking processing (S2105).

In step 2106, the correction coefficient deriving unit 1901 determines whether the light beam tracking processing of all the pixels is completed. When not completed, the procedure returns to step 2103 and the next pixel to be subjected to the processing is selected. On the other hand, when completed, the procedure proceeds to step 2107.

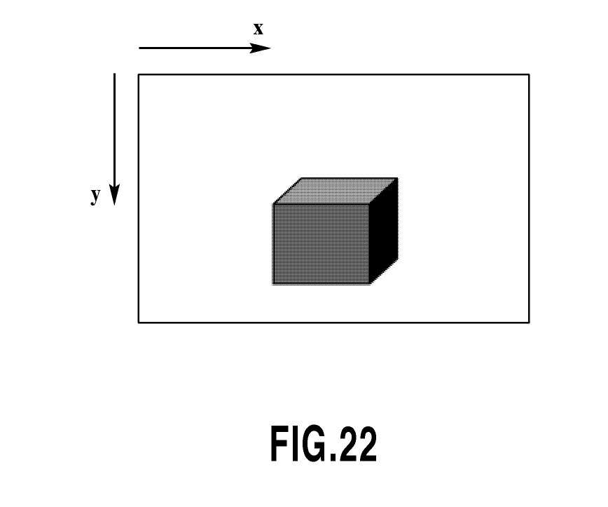

In step 2107, the correction coefficient deriving unit 1901 derives the correction coefficient α from the color signal value of the virtual subject. FIG. 22 shows an image when the reflection characteristic of the virtual subject is set to the virtual standard reflectance of 18%. The correction coefficient α is a coefficient to correct the color signal value of the virtual subject shown in FIG. 22 to D/2. If it is assumed that the color signal values acquired in step 2105 are [R′, G′, B′], an average value A′ of the color signal values G′ of the virtual subject is found from Expression (26) and it is possible to find the correction coefficient α from the obtained average value A′ and Expression (27). Note that, here, the correction coefficient is derived from all the pixels configuring the virtual subject, but it may also be possible to derive the correction coefficient from only the pixels of part of the virtual subject, which tends to attract attention (face region when the virtual subject is a person).

$$\begin{matrix}[ Formula 26 ] & \\ {A}^{′} = \frac{{\sum }_{N} {G}^{′}}{N} & Expression ( 26 ) \\ [ Formula 27 ] & \\ α = \frac{D}{2 \times {A}^{′}} & Expression ( 27 )\end{matrix}$$

In this manner, the correction coefficient α is found.

Explanation is returned to the flowchart of FIG. 20.

In step 2003, the virtual subject combining unit 1902 generates an image of the background image combined with the virtual subject based on the acquired background image, environment map, and virtual subject information, and the derived correction coefficient α.

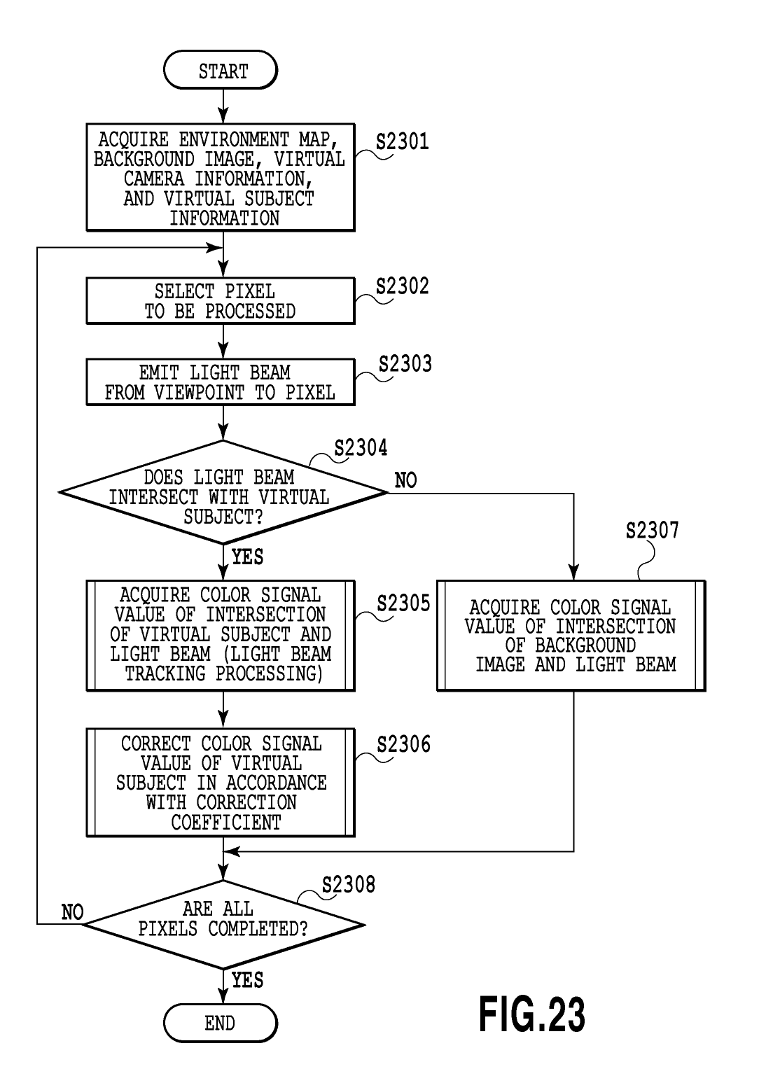

FIG. 23 is a flowchart showing a flow of the virtual subject combination processing in the present step. The virtual subject combination processing according to the present embodiment differs from the virtual subject combination processing according to the first embodiment in that after the color signal value of the virtual subject is acquired, the color signal value of the virtual subject is corrected based on the correction coefficient α obtained by the above-described correction coefficient derivation processing and the virtual subject is combined with the background image.

In step 2301, the virtual subject combining unit 1902 acquires the environment map, the virtual camera information, the virtual subject information, and the background image.

In step 2302, the virtual subject combining unit 1902 selects a pixel to be subjected to the processing to acquire the color signal value from the background image.

In step 2303, the virtual subject combining unit 1902 emits a light beam toward the selected pixel from the viewpoint position specified in the virtual camera information acquired in step 2301.

In step 2304, the virtual subject combining unit 1902 determines whether or not the emitted light beam intersects with the virtual subject. When it is determined that the emitted light beam intersects with the virtual subject, the procedure proceeds to step 2305 and when it is determined that the light beam does not intersect with the virtual subject, the procedure proceeds to step 2307.

In step 2305, the virtual subject combining unit 1902 acquires the color signal value of the selected pixel, in this case, the color signal value at the intersection of the virtual subject and the light beam is acquired.

In step 2306, the virtual subject combining unit 1902 corrects the color signal value of the virtual subject acquired in step 2305 in accordance with the correction coefficient α derived in step 2002 described previously. Specifically, the color signal values [R_{c}, G_{c}, B_{c}] after the correction of the color signal values [R, G, B] of the virtual subject acquired in step 2305 are found by multiplication by the correction coefficient α, that is, by Expressions (28) to (30) below, respectively.

R_{c}=α×R Expression (28)

G_{c}=α×G Expression (29)

B_{c}=α×B Expression (30)

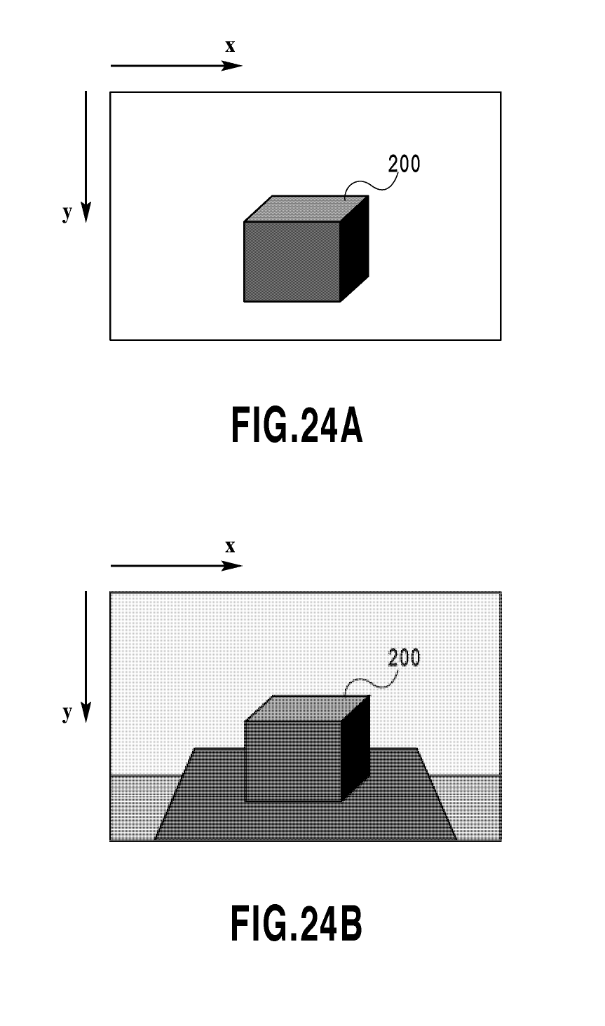

Due to this, for example, the virtual subject image shown in FIG. 18A described previously is corrected into a virtual subject image with appropriate exposure as shown in FIG. 24A.

In step 2307, the virtual subject combining unit 1903 acquires the color signal value at the intersection of the background image acquired in step 2301 and the light beam emitted in step 2303.

By the above processing, a combined image is obtained, which is a combination of the background image and the virtual subject the exposure of which is corrected to appropriate exposure. FIG. 24B shows a combined image obtained by combining the virtual subject image after the correction shown in FIG. 24A with the background image with appropriate exposure. Compared to FIG. 18B, it can be seen that the brightness of the virtual subject and that of the background image are the same and a more natural combined image is obtained.

Explanation is returned to the flowchart of FIG. 20.

In step 2004, the virtual subject combining unit 1902 outputs the data of the combined image generated in the virtual subject combination processing described above.

As above, according to the present embodiment, by generating a virtual subject image with appropriate exposure in the processing to generate a combined image of an actually-photographed background image and a virtual subject, it is made possible to automatically generate a natural combined image.

### Fourth Embodiment

In the first to third embodiments, the correction coefficient used to correct the difference in white balance and brightness between light with which the virtual subject is irradiated and the background image is derived based on the color signal value obtained by performing rendering of an achromatic color object etc. That is, it is necessary to perform temporary rendering in addition to the original rendering. Next, an aspect is explained as a fourth embodiment, in which the correction coefficient is derived without performing such temporary rendering. Note that, explanation of parts common to those of the first to third embodiments is simplified or omitted and different points are explained mainly.

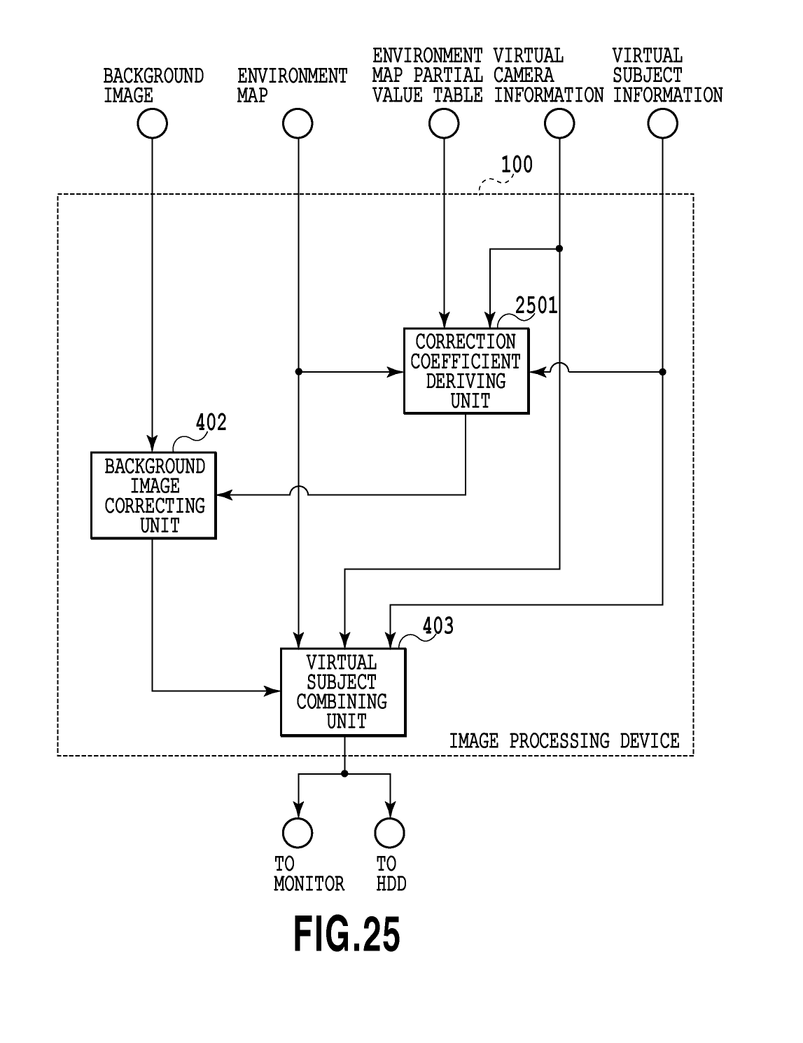

FIG. 25 is a functional configuration diagram of an image processing device according to the present embodiment. The configuration shown in FIG. 25 is realized as image processing application software. FIG. 25 is substantially the same as the functional configuration diagram (see FIG. 4) of the image processing device according to the first embodiment, but the environment map is not input to a correction coefficient deriving unit 2501 but input only to the virtual subject combining unit 403. Then, in place of the environment map, an environment map partial value table is input to the correction coefficient deriving unit 2501. The environment map partial value table is described later.

The correction coefficient deriving unit 2501 in the present embodiment derives the correction coefficient using the input virtual camera information, virtual subject information, and environment map partial value table. The derived correction coefficient is stored in the RAM 102. The background image correcting unit 402 and the virtual subject combining unit 403 are quite the same as those of the first embodiment, and therefore, explanation is omitted.

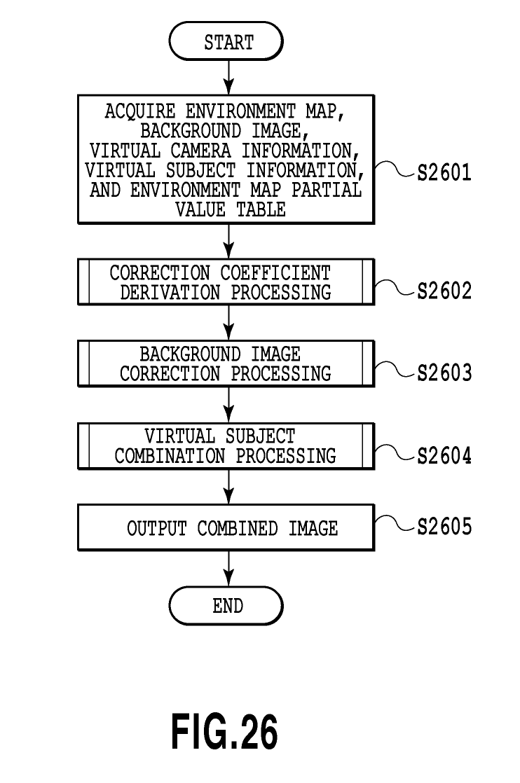

FIG. 26 is a flowchart showing a general flow of image processing performed in the image processing device 100 according to the present embodiment.

In step 2601, the image processing device 100 acquires the background image, the environment map, the environment map partial value table, the virtual camera information, and the virtual subject information. Of the acquired data, the environment map partial value table, the virtual camera information, and the virtual subject information are sent to the correction coefficient deriving unit 2501 and the background image, the environment map, the virtual camera information, and the virtual subject information are sent to the virtual subject combining unit 403. Moreover, the background image is sent to the background image correcting unit 402.

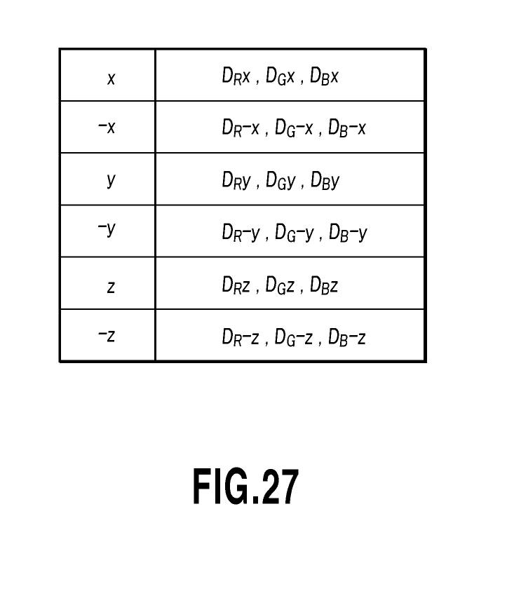

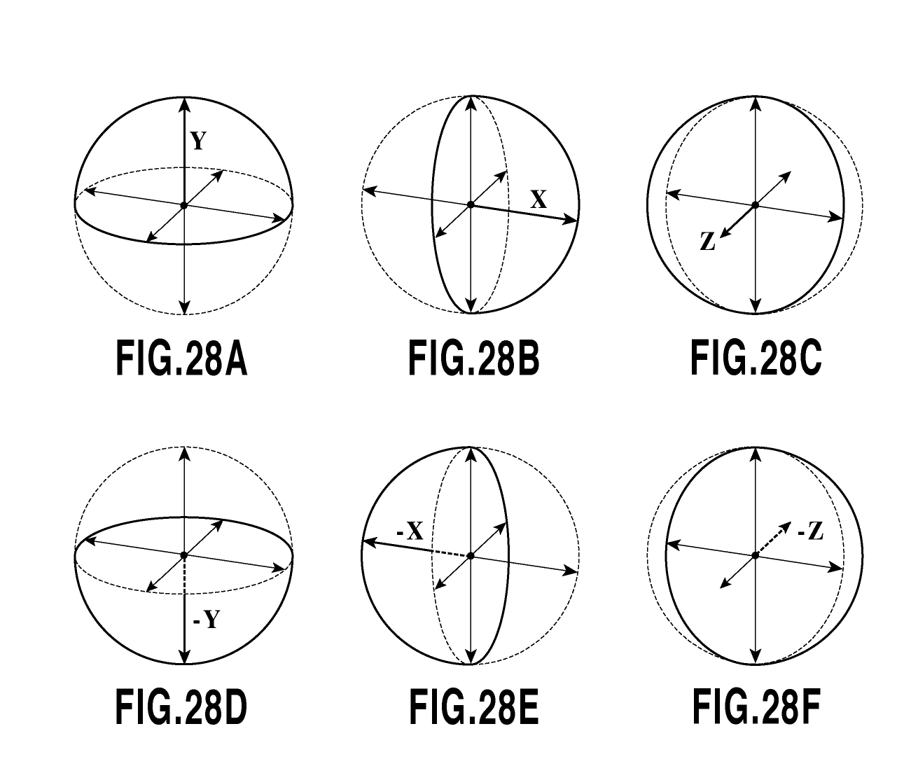

In step 2602, the correction coefficient deriving unit 2501 derives the correction coefficient using the input virtual camera information, virtual subject information, and environment map partial value table. Here, the environment map partial value table holds the pixel value average of each specific region within the environment map as a list and in which the vector from the origin toward the center of each region and the pixel value average in each region are held in association with each other. FIG. 27 is an example of the environment map partial value table and as to all six vectors in the positive and negative directions of the x, y, and z axes, the pixel value averages (D_{R}, D_{G}, D_{B}) in the regions to the center of which each vector points are held. The pixel value averages (D_{R}, D_{G}, D_{E}) relatively represent the light beam with which the origin is irradiated from each region of the environment map. FIGS. 28A to 28F each show a specific region (hemisphere) corresponding to the pixel value averages (D_{R}, D_{G}, D_{E}) of each vector (in the positive and negative directions of the x, y, and z axes) in the environment map partial value table of FIG. 27. In the present embodiment, the shape when dividing the environment map into specific regions is a hemisphere with each of all the six vectors in the positive and negative directions of the x, y, and z axes in the virtual space as a center, but the number of vectors and the shape (wide or narrow) of the region are not limited to the above. For example, by increasing the number of vectors, it is possible to obtain a result with high precision, but the burden of processing increases on the contrary, and therefore, the number of vectors and the shape are set appropriately by taking the balance thereof into consideration. The derived correction coefficient is stored in the RAM 102.

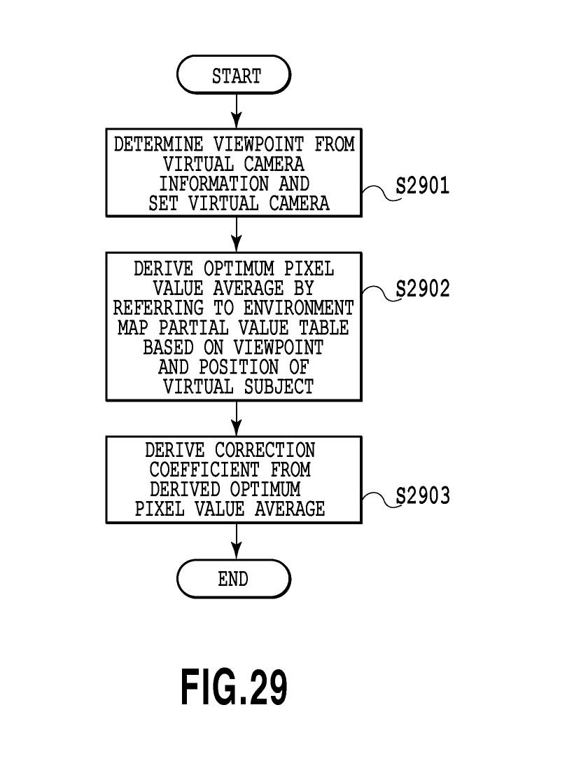

FIG. 29 is a flowchart showing details of correction coefficient derivation processing in the present step.

In step 2901, the correction coefficient deriving unit 2501 determines a viewpoint based on the virtual camera information acquired in step 2601 described previously and sets a photographing position of the virtual camera. The present step is the same as step 601 of the flowchart of FIG. 6 according to the first embodiment.

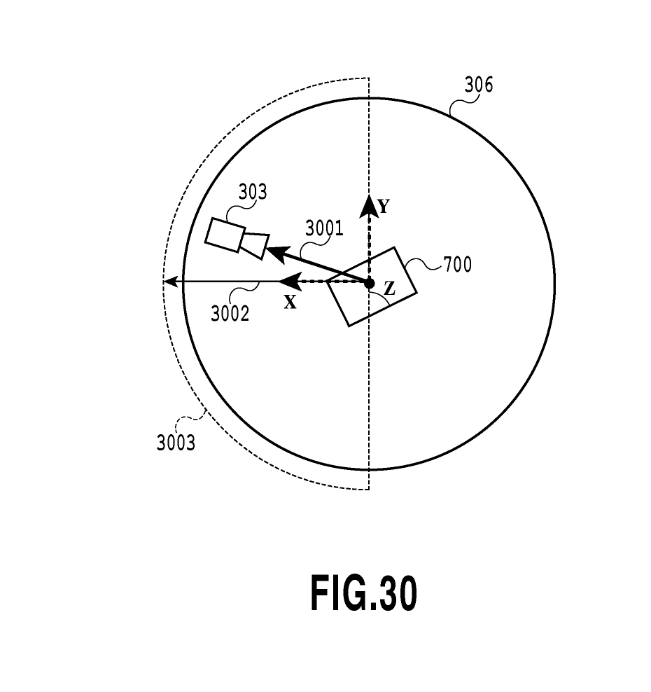

In step 2902, the correction coefficient deriving unit 2501 first sets a position of the virtual subject from the virtual subject information. Then, based on the photographing position (viewpoint) of the virtual camera set in step 2901 and the position of the virtual subject set as above, the correction coefficient deriving unit 2501 acquires the pixel value averages (D_{R}, D_{G}, D_{E}) as light that affects the virtual subject by referring to the environment map partial value table described previously. For example, a vector from the virtual subject toward the virtual camera is taken to be V and by selecting the vector closest to the vector V from the vectors within the environment map partial value table, the optimum pixel value average is obtained. FIG. 30 is a diagram for explaining the way the pixel value average as light that affects the virtual subject is acquired. In FIG. 30, an arrow 3001 from the virtual subject 700 toward the virtual camera 303 indicates the vector V. A vector (vector along the X axis) indicated by an arrow 3002, which is closest to the vector V3001, is selected from the environment map partial value table and the pixel value average associated with the vector is obtained. Note that, a broken line 3003 indicates a region (hemisphere) corresponding to the vector 3002. Here, a case is explained where only one vector is selected that is in the position closest to the vector V from the virtual subject 700 toward the virtual camera 303, but it may also be possible to obtain the optimum pixel value average by selecting a plurality of vectors in the positions close to the vector V and by calculating a weighted average of the pixel value averages corresponding to the plurality of selected vectors. In this manner, in the present embodiment, by specifying a region that affects the virtual subject in the environment map without performing temporary rendering, with which light the virtual subject is irradiated is specified.

In step 2903, the correction coefficient deriving unit 2501 derives the correction coefficient from the acquired pixel value averages (D_{R}, D_{G}, D_{E}). The correction coefficient may be any value as long as the white balance of the pixel value averages (D_{R}, D_{G}, D_{E}) acquired in step 2902 can be corrected by the value. Specifically, by using the acquired optimum pixel value averages (D_{R}, D_{G}, D_{E}) in place of the color signal values (r_{x, y}, g_{x, y}, b_{x, y}) in Expressions (14) and (16) shown in the first embodiment, the correction coefficients (t_{R}, t_{G}, t_{B}) are derived.

Explanation is returned to the flowchart of FIG. 26.

The subsequent step 2603 (background image correction processing), step 2604 (virtual subject combination processing), and step 2605 (combined image output processing) are the same as steps 503 to 505 of the flowchart of FIG. 5 according to the first embodiment, and therefore, explanation is omitted.

As above, according to the present embodiment, it is possible to derive the correction coefficient without performing temporary rendering using an achromatic color object etc. and it is made possible to perform processing at a high speed.

### Fifth Embodiment

In the fourth embodiment, the pixel value average as light that affects the virtual subject is acquired from the environment map partial value table based on the position of the virtual subject and the position of the virtual camera. That is, in the fourth embodiment, the optimum pixel value average is acquired based on only the positional relationship between the subject and the camera, but this premises that the normal vector of the subject points to the virtual camera. Consequently, if the orientation of the normal vector of the virtual subject deviates considerably from the position of the virtual camera, the light with which the virtual subject is irradiated actually will be quite different from the result obtained from the environment map partial value table. Therefore, an aspect is explained as a fifth embodiment, in which in addition to the positional relationship of the virtual subject, the shape thereof is also taken into consideration. It should be noted that explanation of parts common to those of the first to fourth embodiments is simplified or omitted and the different points are explained mainly.

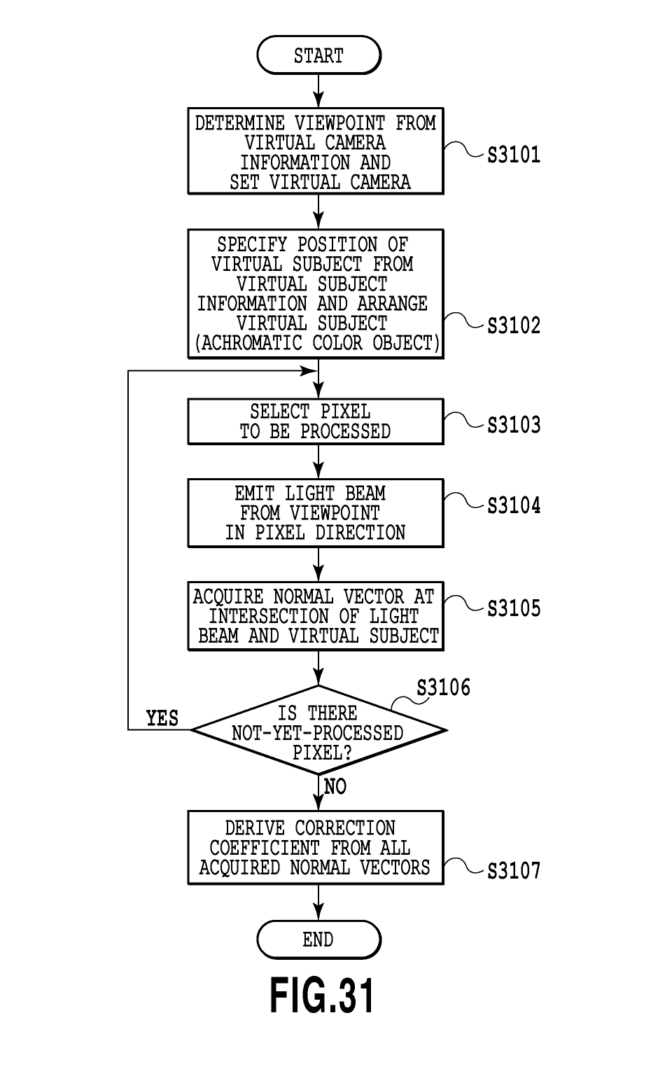

FIG. 31 is a flowchart showing a flow of correction coefficient derivation processing according to the present embodiment. Note that, the configuration of the image processing device in the present embodiment is the same as that of FIG. 25 shown in the fourth embodiment, and therefore, explanation is given based on FIG. 25.

In step S3101, the correction coefficient deriving unit 2501 determines a viewpoint from the virtual camera information and sets a photographing position of the virtual camera.

In step 3102, the correction coefficient deriving unit 2501 specifies the set position of the virtual subject from the virtual subject information and arranges the virtual subject as an achromatic color object in the specified position.

In step 3103, the correction coefficient deriving unit 2501 selects a pixel to be subjected to the processing of the above-mentioned virtual subject viewed from the virtual camera.

In step 3104, the correction coefficient deriving unit 2501 emits a light beam from the viewpoint (set position of the virtual camera) determined in step 3101 in the direction of the select pixel.

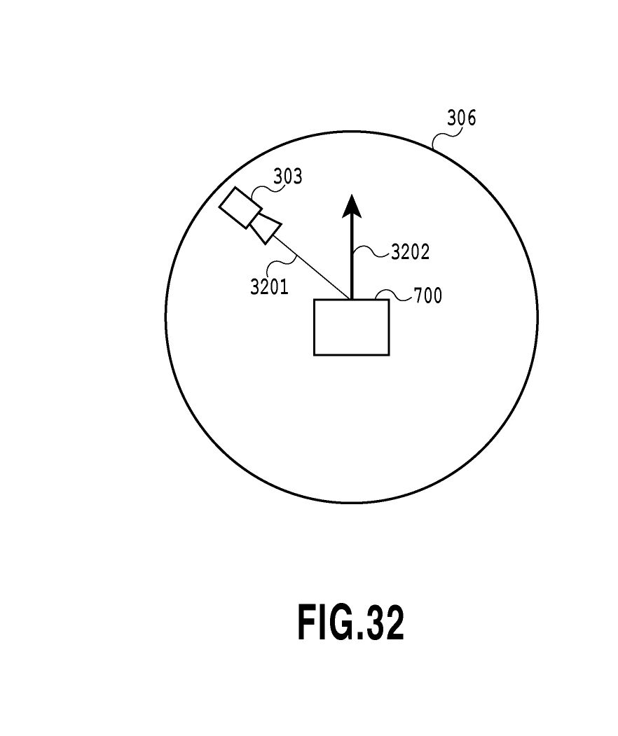

In step 3105, the correction coefficient deriving unit 2501 acquires the normal vector at the intersection of the emitted light beam and the virtual subject. FIG. 32 is a diagram showing the way the normal vector is acquired. In FIG. 32, an arrow 3201 indicates the light beam emitted toward the virtual subject 700 in step 3104 and a vertical arrow 3202 from the intersection of the light beam. 3201 and the virtual subject 700 toward the environment map 306 indicates the normal vector to be found.

In step 3106, the correction coefficient deriving unit 2501 determines whether the processing of all the pixels is completed. That is, whether all the normal vectors on the virtual subject corresponding to the respective pixels of the virtual subject viewed from the viewpoint of the virtual camera are acquired is determined. When there is a not-yet-processed pixel, the procedure returns to step 3103 and the next pixel to be processed is selected. On the other hand, when completed, the procedure proceeds to step 3107.

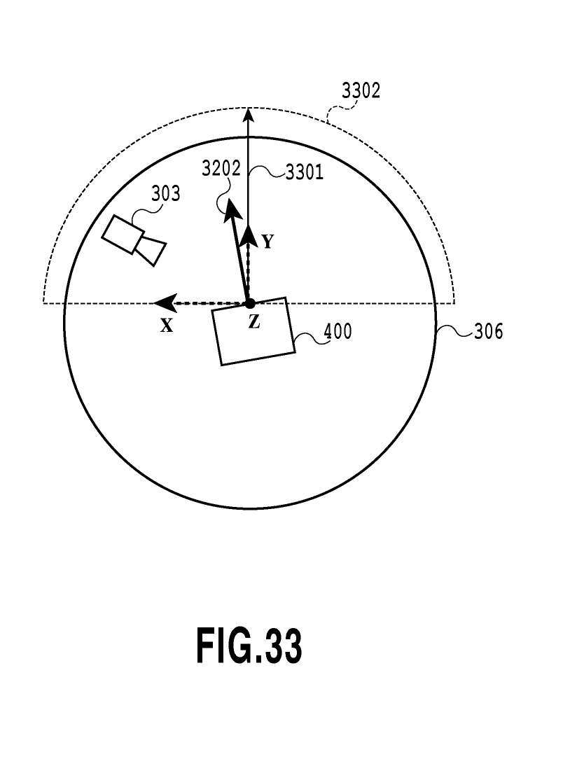

In step 3107, the correction coefficient deriving unit 2501 derives the correction coefficient from all the acquired normal vectors. Specifically, first, the correction coefficient deriving unit 2501 derives the optimum pixel value averages (D_{R}, D_{G}, D_{E}) of all the normal vectors by referring to the environment map partial value table. For example, as to all the normal vectors, the correction coefficient deriving unit 2501 selects the closest vector from the vectors within the environment map partial value table and obtains the pixel value averages (D_{R}, D_{G}, D_{E}) corresponding to the selected vector. Alternatively, it may also be possible to find the average vector of all the normal vectors, select the vector closest to the obtained average vector from the vectors within the environment map partial value table, and obtain the pixel value averages (D_{R}, D_{G}, D_{E}) corresponding to the selected vector. FIG. 33 is a diagram for explaining the way the vector closest to the normal vector is selected. The vector (vector along the Y axis) indicated by an arrow 3301 closest to the normal vector 3202 is selected from the environment map partial value table and the pixel value average associated with the vector is acquired. Note that, a broken line 3302 indicates a region (hemisphere) corresponding to the vector 3301. Then, as in the fourth embodiment, from the derived optimum pixel value averages (D_{R}, D_{G}, D_{E}), the correction coefficients (t_{R}, t_{G}, t_{B}) are derived by using the derived optimum pixel value averages (D_{R}, D_{G}, D_{E}) in place of the color signal values (r_{x, y}, g_{x, y}, b_{x, y}) in Expressions (14) and (16).

As above, in the present embodiment, the pixel value average as light that affects the virtual subject is obtained from the normal vector and the environment map partial value table, and therefore, it is not necessary to emit a plurality of light beams as in the first embodiment. Therefore, compared to the first embodiment in which temporary rendering is performed, it is possible to relieve the burden of processing and it is made possible to perform processing at a higher speed.

### Sixth Embodiment

Both the fourth and fifth embodiments are based on the first embodiment. That is, the background image is corrected using the derived correction coefficient. However, the contents disclosed in the fourth and fifth embodiments are not limited to the case where the background image is corrected and can also be applied to the case where the environment map is corrected as in the second embodiment. In that case, various kinds of processing are performed based on the processing in the second embodiment explained using FIGS. 15 to 17. For example, in the case of the fourth embodiment, to the first correction coefficient deriving unit 1501, the environment map partial value table is input, the correction coefficient is derived in the correction coefficient derivation processing according to step 2602 of the flowchart of FIG. 26, the environment map is corrected in accordance with the derived environment map, and so on.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-250649, filed Nov. 16, 2011 and 2012-217162, filed Sep. 28, 2012 which are hereby incorporated by reference herein in their entirety.

What is claimed is:

1. An image processing device that combines a virtual subject with a background image to generate a combined image, the device comprising:
a correction coefficient deriving unit configured to derive a correction coefficient by performing rendering of a color object arranged in a position where the virtual subject is placed using an environment map indicating information of a light source around the virtual subject;
a background image correcting unit configured to correct the background image based on the derived correction coefficient; and
a combining unit configured to combine a corrected background image and the virtual subject using the environment map.

2. The image processing device according to claim 1, wherein the color object is an achromatic color object.

3. An image processing device that combines a virtual subject with a background image to generate a combined image, the device comprising:
a first correction coefficient deriving unit configured to derive a first correction coefficient by performing rendering of a color object arranged in a position where the virtual subject is placed using an environment map indicating information of a light source around the virtual subject;
a second correction coefficient deriving unit configured to derive a second correction coefficient from the background image;
an environment map correcting unit configured to correct the environment map based on the derived first correction coefficient and second correction coefficient; and
a combining unit configured to combine the background image and the virtual subject using a corrected environment map.

4. The image processing device according to claim 3, wherein the color object is an achromatic color object.

5. The image processing device according to claim 1, wherein
the correction coefficient derived by the correction coefficient deriving unit is a ratio of color components of a color obtained from the rendering result of the color object.

6. The image processing device according to claim 3, wherein
the first correction coefficient derived by the first correction coefficient deriving unit is a ratio of color components obtained from the rendering result of the color object, and
the second correction coefficient derived by the second correction coefficient deriving unit is a ratio of color components obtained from the white balance of the background image.

7. The image processing device according to claim 2, wherein
the achromatic color object is a white ball.

8. An image processing device that combines a virtual subject with a background image to generate a combined image, the device comprising:
a correction coefficient deriving unit configured to derive a correction coefficient by performing rendering of the virtual subject to which a predetermined reflection characteristic is set; and
a combining unit configured to correct a color signal value of the virtual subject based on the derived correction coefficient and to combine the background image and the virtual subject the color signal value of which is corrected using the environment map.

9. The image processing device according to claim 8, wherein
the predetermined reflection characteristic is a perfect diffuse reflection characteristic and is a gray scale characteristic.

10. An image processing device that combines a virtual subject with a background image to generate a combined image, the device comprising:
a setting unit configured to set a viewpoint for observing a virtual subject;
a correction coefficient deriving unit configured to specify a region of a light source that affects the virtual subject in an environment map indicating information of a light source around the virtual subject based on the set viewpoint and to derive a correction coefficient based on the specified region;
a background image correcting unit configured to correct the background image based on the derived correction coefficient; and
a combining unit configured to combine a corrected background image and the virtual subject using the environment map.

11. An image processing device that combines a virtual subject with a background image to generate a combined image, the device comprising:
a setting unit configured to set a viewpoint for observing a virtual subject;
a correction coefficient deriving unit configured to specify a region of a light source that affects the virtual subject in an environment map indicating information of a light source around the virtual subject based on the set viewpoint and to derive a correction coefficient based on the specified region;
an environment map correcting unit configured to correct the environment map based on the derived correction coefficient; and
a combining unit configured to combine the background image and the virtual subject using a corrected environment map.

12. The image processing device according to claim 10, wherein
the correction coefficient deriving unit specifies a region of a light source that affects the virtual subject based on a vector from the position where the virtual subject is placed toward the viewpoint.

13. The image processing device according to claim 10, wherein
the correction coefficient deriving unit emits a light beam from the viewpoint toward the position where the virtual subject is placed, acquires a normal vector at the intersection of the light beam and the virtual subject, and specifies a region of a light source that affects the virtual subject based on the acquired normal vector.

14. The image processing device according to claim 10, wherein
the correction coefficient deriving unit derives a correction coefficient by acquiring an average value of pixel values corresponding to the specified region using an environment map partial value table.

15. The image processing device according to claim 14, wherein
the environment map partial value table is a table in which the average value of pixel values of each region of the environment map and a vector from the origin toward each region are held in association with each other.

16. The image processing device according to claim 10, wherein
the correction coefficient deriving unit derives a correction coefficient by weight-averaging the average value of pixel values of each region when the number of specified regions is two or more.

17. An image processing method of combining a virtual subject with a background image to generate a combined image, the method comprising the steps of:
deriving a correction coefficient by performing rendering of a color object arranged in a position where the virtual subject is placed using an environment map indicating information of a light source around the virtual subject;
correcting the background image based on the derived correction coefficient; and
combining a corrected background image and the virtual subject using the environment map.

18. An image processing method of combining a virtual subject with a background image to generate a combined image, the method comprising the steps of:
deriving a first correction coefficient by performing rendering of a color object arranged in a position where the virtual subject is placed using an environment map indicating information of a light source around the virtual subject;
deriving a second correction coefficient from the background image;
correcting the environment map based on the derived first correction coefficient and second correction coefficient; and
combining the background image and the virtual subject using a corrected environment map.

19. An image processing method of combining a virtual subject with a background image to generate a combined image, the method comprising the steps of:
setting a viewpoint for observing a virtual subject;
specifying a region corresponding to a light source that affects the virtual subject in an environment map indicating information of a light source around the virtual subject based on the set viewpoint and deriving a correction coefficient based on the specified region;
correcting the background image based on the derived correction coefficient; and
combining a corrected background image and the virtual subject using the environment map.

20. An image processing method of combining a virtual subject with a background image to generate a combined image, the method comprising the steps of:
setting a viewpoint for observing a virtual subject;
specifying a region corresponding to a light source that affects the virtual subject in an environment map indicating information of a light source around the virtual subject based on the set viewpoint and deriving a correction coefficient based on the specified region;
correcting the environment map based on the derived correction coefficient; and
combining a background image and the virtual subject using a corrected environment map.

21. A program stored in a non-transitory computer readable storage medium for causing a computer to perform the image processing method according to claim 17.

22. A program stored in a non-transitory computer readable storage medium for causing a computer to perform the image processing method according to claim 18.

23. A program stored in a non-transitory computer readable storage medium for causing a computer to perform the image processing method according to claim 19.

24. A program stored in a non-transitory computer readable storage medium for causing a computer to perform the image processing method according to claim 20.
